(19) United States
(12) Patent Application Publication
(10) Pub. No.: US 2026/0267147 A1
(43) Pub. Date: Sep. 10, 2026

(54) ELECTRONIC DEVICE AND OPERATION METHOD THEREOF

(71) Applicant: Semiconductor Energy Laboratory Co., Ltd., Atsugi-shi, Kanagawa-ken (JP)

(72) Inventors: Ryo HATSUMI, Hadano (JP); Hisao IKEDA, Zama (JP); Daiki NAKAMURA, Atsugi (JP); Tomotaka NISHIMURA, Kawasaki (JP)

(21) Appl. No.: 19/489,285

(22) PCT Filed: Jul. 18, 2024
(86) PCT No.: PCT/IB2024/056950

§ 371 Date: Dec. 2, 2025

(30) Foreign Application Priority Data
Jul. 25, 2023 (JP) 2023-120401

(51) Int. Cl. G02B 27/01; G02F 1/1335; G02F 1/13357; G02F 1/13363

(52) U.S. Cl. CPC G02B 27/0172; G02B 27/0176; G02F 1/133536; G02F 1/133557; G02F 1/133602; G02F 1/133638; G02B 2027/013; G02B 2027/015; G02B 2027/0152; G02B 2027/0178

(57) ABSTRACT

An electronic device with good visibility of display is provided. The electronic device includes a reflective liquid crystal display device for displaying information, and part of external light taken into the electronic device can be supplied to the reflective liquid crystal display device to be used as a light source of display light. Thus, the visibility of display can be increased even when external light is intense. Furthermore, since external light is utilized for display, power consumption can be reduced compared with a transmissive liquid crystal display device that constantly uses a light source, a self-luminous organic EL display device, and the like.

### TECHNICAL FIELD

One embodiment of the present invention relates to an electronic device.

Note that one embodiment of the present invention is not limited to the above technical field. The technical field of one embodiment of the invention disclosed in this specification and the like relates to an object, a method, or a manufacturing method. Alternatively, one embodiment of the present invention relates to a process, a machine, manufacture, or a composition of matter. Accordingly, more specific examples of the technical field of one embodiment of the present invention disclosed in this specification include a semiconductor device, a display device, a liquid crystal display device, a light-emitting apparatus, a lighting device, a power storage device, a memory device, an imaging device, an operation method thereof, and a manufacturing method thereof.

Note that in this specification and the like, a semiconductor device generally means a device that can function by utilizing semiconductor characteristics. A transistor and a semiconductor circuit are embodiments of semiconductor devices. In addition, in some cases, a memory device, a display device, an imaging device, or an electronic device includes a semiconductor device.

### BACKGROUND ART

As one kind of display devices, an active matrix liquid crystal display device in which transistors are used as switching elements is known (Patent Document 1).

Liquid crystal display devices are roughly divided into two types: a transmissive liquid crystal display device and a reflective liquid crystal display device. In addition, a transflective type, which is a combination of the above two types, is also known.

A transmissive liquid crystal display device controls a state where light entering from a backlight passes through the liquid crystal display device to be output to the outside (bright) and a state where the light is not output (dark) by optical modulation action of a liquid crystal, whereby an image can be displayed.

A reflective liquid crystal display device controls a state where light entering from a display surface side is reflected by a pixel electrode and is output to the outside (bright) and a state where light is not output (dark) by optical modulation action of a liquid crystal, whereby an image can be displayed.

### REFERENCE

### Patent Document

[Patent Document 1] WO2023/094937

### SUMMARY OF THE INVENTION

### Problems to be Solved by the Invention

An optical see-through glasses-type device used as a device compatible with augmented reality (AR) or the like is required to have high visibility of displayed information regardless of the illuminance of a usage environment. Moreover, the optical see-through glasses-type device is also desired to have low power consumption for a reduction in the frequency of charging while being small and lightweight, for the sake of a long continuous use.

As a display device used for a glasses-type device, a transmissive liquid crystal display device with good visibility in a relatively wide illuminance range or a self-luminous display device including an organic EL element or the like is often used. However, a problem with these display devices is that the visibility of display is decreased at a high illuminance because the amount of light for display becomes relatively small with respect to external light. Furthermore, power consumption is increased in order to increase the luminance of display at a high illuminance.

A reflective liquid crystal display device utilizes reflected light and thus has high visibility of display at a high illuminance. In the case where a reflective liquid crystal display device is used for a glasses-type device, the luminance can be increased when external light can be used as display light, and visibility can be improved. Although a light source such as a front light is needed to increase visibility at a low illuminance, the use of external light in combination can reduce electric power needed for the light source.

Thus, an object of one embodiment of the present invention is to provide an electronic device with good visibility of display. Another object is to provide an electronic device with low power consumption. Another object is to provide a small and lightweight electronic device. Another object is to provide a novel electronic device. Another object is to provide a method for operating the electronic device.

Note that the description of these objects does not preclude the presence of other objects. One embodiment of the present invention does not necessarily achieve all these objects. Note that other objects will be apparent from the description of the specification, the drawings, the claims, and the like, and other objects can be derived from the description of the specification, the drawings, the claims, and the like.

### Means for Solving the Problems

One embodiment of the present invention relates to an electronic device with good visibility of display.

One embodiment of the present invention is an electronic device including a reflective liquid crystal display device, a planar light source, a reflective polarizing plate, a retardation plate, and a half mirror; a display surface of the reflective liquid crystal display device faces a light-emitting surface of the planar light source; the reflective polarizing plate is provided at an angle at which light that is emitted from the display surface and travels straight through the planar light source is incident obliquely; and the retardation plate and the half mirror are provided in this order from the reflective polarizing plate side in a direction in which light reflected by the reflective polarizing plate travels.

The half mirror can have a concave surface on the reflective polarizing plate side.

The reflective liquid crystal display device can include a linear polarizing plate, a liquid crystal layer, and a reflective layer in this order from the planar light source side. In addition, a retardation plate may be provided between the linear polarizing plate and the liquid crystal layer.

The planar light source includes a light-emitting source and a light guide plate, the light-emitting source includes a first to a third light source, the first light-emitting source has a function of emitting red light, the second light-emitting source has a function of emitting green light, the third light-emitting source has a function of emitting blue light, and the first to the third light source can each have a function of adjusting emission intensity. A lens may be provided between the planar light source and the reflective polarizing plate.

Another embodiment of the present invention is an electronic device including a transflective liquid crystal display device, a planar light source, a reflective polarizing plate, a retardation plate, and a half mirror; a surface opposite to the display surface of the transflective liquid crystal display device faces a light-emitting surface of the planar light source; the reflective polarizing plate is provided at an angle at which light that is emitted from the display surface and travels straight is incident obliquely; and the retardation plate and the half mirror are provided in this order from the reflective polarizing plate side in a direction in which light reflected by the reflective polarizing plate travels.

The half mirror can have a concave surface on the reflective polarizing plate side.

The transflective liquid crystal display device can include a first linear polarizing plate, a liquid crystal layer, a transflective layer, and a second linear polarizing plate in this order from the reflective polarizing plate side.

The transflective layer can be a half mirror type. Alternatively, the transflective layer may include a reflective layer and a light-transmitting layer.

The planar light source includes a light-emitting source and a light guide plate; the planar light source includes a reflective layer on a surface opposite to the light-emitting surface; the light-emitting source includes a first to a third light-emitting source; the first light-emitting source has a function of emitting red light; the second light-emitting source has a function of emitting green light; the third light-emitting source has a function of emitting blue light; and the first to the third light-emitting source can each have a function of adjusting emission intensity.

Alternatively, the planar light source has a function of transmitting light, the planar light source includes a light-emitting source and a light guide plate, the light-emitting source includes a first to a third light-emitting source, the first light-emitting source has a function of emitting red light, the second light-emitting source has a function of emitting green light, the third light-emitting source has a function of emitting blue light, and the first to the third light-emitting source can each have a function of adjusting emission intensity.

The electronic device includes a housing; the transflective liquid crystal display device, the planar light source, the reflective polarizing plate, the retardation plate, and the half mirror are stored in the housing; and a lighting window may be provided in a region overlapping with the planar light source in the housing. A lens may be provided between the transflective liquid crystal display device and the reflective polarizing plate.

Another embodiment of the present invention is a method for operating an electronic device including a reflective liquid crystal display device or a transflective liquid crystal display device on which light is incident from a first light source and a second light source; the illuminance and chromaticity of light emitted from the first light source are obtained with a photometric sensor; the illuminance of the second light source is changed so as to have a negative slope with respect to the illuminance; and the chromaticity of light emitted from the second light source is changed in accordance with the chromaticity such that light incident on the reflective liquid crystal display device or the transflective liquid crystal display device is white or a color in the vicinity thereof.

### Effect of the Invention

According to one embodiment of the present invention, an electronic device with good visibility of display can be provided. An electronic device with low power consumption can be provided. Alternatively, a small and lightweight electronic device can be provided. A novel electronic device can be provided. Alternatively, a method for operating the electronic device can be provided.

Note that the description of these effects does not preclude the presence of other effects. One embodiment of the present invention does not necessarily have all of these effects. Other effects can be derived from the description of the specification, the drawings, and the claims.

### BRIEF DESCRIPTION OF THE DRAWINGS

FIG. 1 is a diagram illustrating an electronic device.

FIG. 2A is a diagram illustrating a planar light source and a reflective liquid crystal display device. FIG. 2B to FIG. 2E are diagrams each illustrating a reflective liquid crystal display device.

FIG. 3A and FIG. 3B are diagrams illustrating a polarization state in an optical path.

FIG. 4A and FIG. 4B are diagrams illustrating light utilization efficiency in an optical path. FIG. 5 is a diagram illustrating an electronic device.

FIG. 6 is a diagram illustrating a planar light source and a reflective liquid crystal display device.

FIG. 7A and FIG. 7B are diagrams illustrating a polarization state in an optical path.

FIG. 8A and FIG. 8B are diagrams illustrating light utilization efficiency in an optical path. FIG. 9 is a diagram illustrating light utilization efficiency in an optical path.

FIG. 10 is a diagram illustrating an electronic device.

FIG. 11A and FIG. 11B are diagrams each illustrating a planar light source and a transflective liquid crystal display device.

FIG. 12A and FIG. 12B are diagrams illustrating a polarization state in an optical path.

FIG. 13A and FIG. 13B are diagrams illustrating light utilization efficiency in an optical path. FIG. 14 is a diagram illustrating light utilization efficiency in an optical path.

FIG. 15A and FIG. 15B are diagrams each illustrating an electronic device.

FIG. 16 is a diagram illustrating an electronic device.

FIG. 17 is a diagram illustrating a display panel.

FIG. 18A to FIG. 18H are diagrams illustrating display panels.

FIG. 19A and FIG. 19B are diagrams illustrating glasses-type devices.

FIG. 20A is a flow chart illustrating an operation of an electronic device. FIG. 20B is a diagram illustrating a function. FIG. 20C is a diagram illustrating wavelength distributions of external light and a planar light source.

FIG. 21 is a diagram illustrating a structure example of a display panel.

FIG. 22 is a diagram illustrating a structure example of a display panel.

FIG. 23 is a diagram illustrating a structure example of a display panel.

FIG. 24 is a diagram illustrating a structure example of a display panel.

FIG. 25 is a diagram illustrating a structure example of a display panel.

FIG. 26A and FIG. 26B are diagrams illustrating a transistor.

FIG. 27A and FIG. 27B are diagrams illustrating a transistor.

FIG. 28A and FIG. 28B are diagrams each illustrating a structure example of a display panel.

### MODE FOR CARRYING OUT THE INVENTION

Embodiments will be described in detail with reference to the drawings. Note that the present invention is not limited to the following description, and it will be readily understood by those skilled in the art that modes and details of the present invention can be modified in various ways without departing from the spirit and scope of the present invention. Therefore, the present invention should not be construed as being limited to the description of embodiments below. Note that in structures of the invention described below, the same reference numerals are used in common, in different drawings, for the same portions or portions having similar functions, and a repeated description thereof is omitted in some cases. Note that the hatching of the same component in drawings is sometimes omitted or changed as appropriate between the drawings.

In addition, even in the case where a single component is illustrated in a circuit diagram, the component may be composed of a plurality of parts as long as there is no functional inconvenience. For example, in some cases, a plurality of transistors each operating as a switch are connected in series or in parallel. Furthermore, in some cases, a capacitor is separated and arranged in a plurality of positions.

In addition, one conductor has functions such as a wiring, an electrode, and a terminal in some cases; in this specification, a plurality of names are sometimes used for one component. Even in the case where components are illustrated in a circuit diagram as if they were directly connected to each other, the components may be actually connected to each other through one or more conductors; in this specification, even such a structure is included in the category of direct connection.

### Embodiment 1

In this embodiment, electronic devices of one embodiment of the present invention will be described.

One embodiment of the present invention is an optical see-through glasses-type device which is an electronic device that can be used as an AR device. The electronic device enables visual perception by superimposing display of a display panel on the outside view.

The electronic device includes a reflective liquid crystal display device for displaying information. Part of external light taken into the electronic device can be made incident on the reflective liquid crystal display device, and the external light is used as a light source for display light. Thus, the visibility of display can be increased even when external light is intense. Furthermore, since external light is used for display, power consumption can be reduced compared with a transmissive liquid crystal display device that constantly uses a light source, a self-luminous organic EL display device, and the like.

Additionally, the electronic device includes a planar light source as a light source of the reflective liquid crystal display device. The planar light source includes light-emitting sources of red light (R), green light (G), and blue light (B), and light emitted from the planar light source can be made incident on the reflective liquid crystal display device together with the external light. Since light incident on the reflective liquid crystal display device is preferably white light, in the case where the chromaticity of external light is biased, the chromaticity of light emitted from the planar light source is adjusted such that light with which the reflective liquid crystal display is irradiated becomes white light. Accordingly, chromaticity adjustment of display can be facilitated.

Note that in this specification and the like, external light refers not only to outdoor light but also to light incident on an electronic device from the outside of the electronic device. Therefore, not only natural light such as sunlight but also direct light and indirect light emitted from a light source (e.g., an electric lamp or a fire) provided indoors/outdoors can all be referred to as external light.

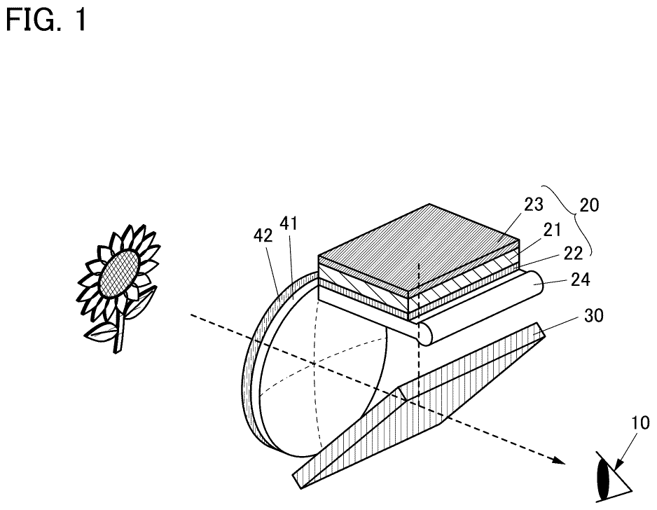

FIG. 1 is a perspective view illustrating an electronic device of one embodiment of the present invention and illustrates a display device, a light source, and an optical device included in the electronic device. Note that the shapes of components illustrated in FIG. 1 are examples.

The electronic device includes a reflective liquid crystal display device 20 as a display device, a planar light source 24 as a light source, a reflective polarizing plate 30 as an optical device, a retardation plate 41, and a half mirror 42.

The reflective liquid crystal display device 20 includes a liquid crystal layer 21, a linear polarizing plate 22, and a reflective layer 23. The liquid crystal layer 21 is provided between the linear polarizing plate 22 and the reflective layer 23, and the user visually perceives light emitted from the linear polarizing plate 22 in accordance with optical modulation of the liquid crystal. Thus, in the reflective liquid crystal display device 20, a surface provided with the linear polarizing plate 22 or a surface of the linear polarizing plate 22 is referred to as a display surface. Note that the reflective liquid crystal display device 20 is simply illustrated in FIG. 1; in the actual structure, the reflective layer 23 is a pixel electrode and is provided for each pixel. The detailed structure of the reflective liquid crystal display device will be described later in the other embodiment.

The planar light source 24 is provided on the display surface side of the reflective liquid crystal display device 20. Although FIG. 1 illustrates an example in which the planar light source 24 and the reflective liquid crystal display device 20 are placed close to each other, they may be placed apart from each other. The planar light source 24 has high transmittance of visible light, and the user can visually perceive display on the reflective liquid crystal display device 20 through the planar light source 24.

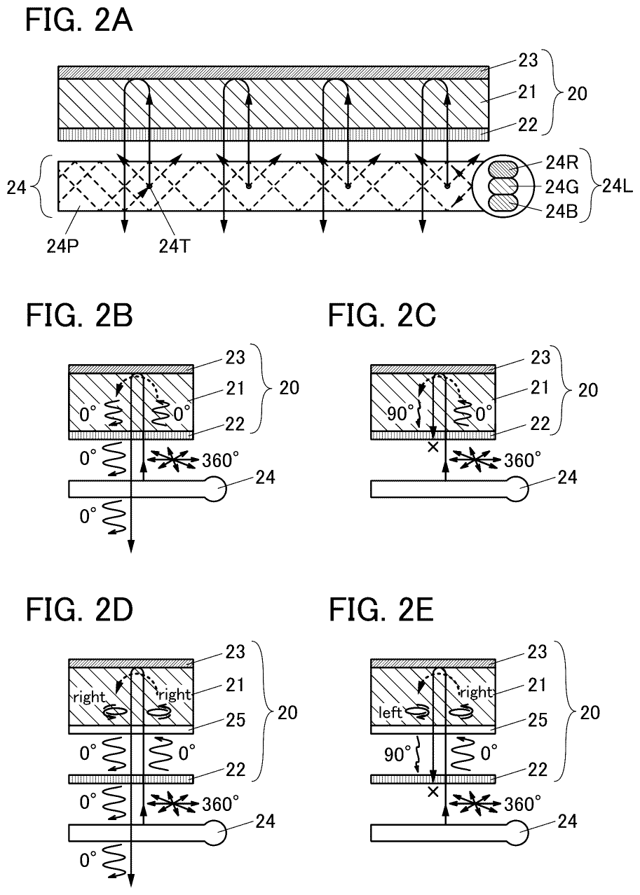

FIG. 2A is a cross-sectional view illustrating a concept of the reflective liquid crystal display device 20 and the planar light source 24. The plane light source 24 includes a light-emitting source 24L in an edge portion. Light emitted from the light-emitting source 24L propagates inside a plate-shaped light guide plate 24P, with its traveling direction changed by minute triggers 24T distributed in the light guide plate 24P, whereby light is extracted in a first surface direction of the light guide plate 24P. The first surface is referred to as a light-emitting surface of the planar light source. As the trigger 24T, an object with a different refractive index from that of the light guide plate, an object with a high reflectance, a surface shape of the light guide plate 24P, or the like can be used.

The light-emitting source 24L includes a light-emitting source 24R, a light-emitting source 24G, and a light-emitting source 24B. As each of the light-emitting source 24R, the light-emitting source 24G, and the light-emitting source 24B, an LED element or the like can be used, for example. The light-emitting source 24R has a function of emitting red light (R). The light-emitting source 24G has a function of emitting green light (G). The light-emitting source 24B has a function of emitting blue light (B). That is, the light-emitting source 24L can emit white light obtained by synthesizing RGB. Moreover, the emission intensity of RGB can be each controlled. The control will be described later in the description of the operation of the electronic device.

Light emitted from the light-emitting surface of the planar light source 24 enters the liquid crystal layer 21 through the linear polarizing plate 22, is turned back by the reflective layer 23, and travels toward the planar light source 24. The planar light source 24 is provided on the display surface side of the reflective liquid crystal display device 20 and thus is also referred to as a front light.

Light emitted from the planar light source 24 is unpolarized light (light oscillating in 360° all directions); for example, as illustrated in FIG. 2B, only 0° linearly polarized light passes through the linear polarizing plate 22 and travels to the liquid crystal layer 21.

Note that although a description is given here under the assumption that the transmission axis of the linear polarizing plate 22 is 0°, 0° is not an absolute value but a reference value. That is, the polarization plane of the linearly polarized light that passes through the linear polarizing plate 22 is regarded as being at 0°. Accordingly, for example, 90° linearly polarized light in this embodiment refers to linearly polarized light obtained by rotating the polarization plane of the linearly polarized light that passes through the linear polarizing plate 22 by 90°.

Light that has traveled to the liquid crystal layer 21 is subjected to optical modulation action of the liquid crystal. The light is turned back by the reflective layer 23, and when the light is in a state of 0° linearly polarized light before reaching the linear polarizing plate 22 again, the light passes through the linear polarizing plate 22. Then, the light is emitted outward through the planar light source 24. The state is visually perceived as bright.

Alternatively, as illustrated in FIG. 2C, when the light subjected to optical modulation action of the liquid crystal is in a state of 90° polarized light before reaching the linear polarizing plate 22 again, the light is absorbed by the linear polarizing plate 22, and the light is not emitted outward. The state is visually perceived as dark.

Although FIG. 2B and FIG. 2C illustrate an example in which a linear polarizing plate is used as the reflective liquid crystal display device 20, a circularly polarizing plate may be used as the reflective liquid crystal display device 20.

FIG. 2D illustrates an example in which a retardation plate 25 is provided between the liquid crystal layer 21 and the linear polarizing plate 22. The combination of the linear polarizing plate 22 and the retardation plate 25 serves as a circularly polarizing plate. Although the linear polarizing plate 22 and the retardation plate 25 are illustrated to be apart from each other, they may be placed close to each other.

Light emitted from the planar light source 24 is unpolarized light; for example, as illustrated in FIG. 2D, only 0° linearly polarized light passes through the linear polarizing plate 22 and travels to the retardation plate 25.

The retardation plate 25 has a function of converting linearly polarized light into circularly polarized light. Here, a λ/4 plate (a quarter-wave plate) can be used as the retardation plate 25. The λ/4 plate is overlaid with the linear polarizing plate 22 such that the angle of the slow axis of the λ/4 plate with respect to the axis of the linearly polarized light emitted from the linear polarizing plate 22 becomes 45°, whereby dextrorotatory circularly polarized light (right circularly polarized light) is obtained. In addition, the λ/4 plate is overlaid with the linear polarizing plate 22 such that the angle of the slow axis of the λ/4 plate with respect to the axis of the linearly polarized light emitted from the linear polarizing plate 22 becomes −45°, whereby levorotatory circularly polarized light (left circularly polarized light) is obtained. The retardation plate 25 also has the opposite function of the above, i.e., a function of converting circularly polarized light into linearly polarized light.

Here, an example in which 0° linearly polarized light is converted into right circularly polarized light by the retardation plate 25 is employed. The right circularly polarized light emitted from the retardation plate 25 travels to the liquid crystal layer 21.

The light (circularly polarized light) that has traveled to the liquid crystal layer 21 is subjected to optical modulation action of the liquid crystal and chiral reversal action of the reflective surface. When the light is in a state of right circularly polarized light before reaching the retardation plate 25 again, the light is converted into 0° linearly polarized light by the retardation plate 25. The 0° linearly polarized light emitted from the retardation plate 25 passes through the linear polarizing plate 22 and is emitted outward through the planar light source 24. The state is visually perceived as bright.

Alternatively, as illustrated in FIG. 2E, when light (circularly polarized light) subjected to optical modulation action of the liquid crystal and chiral reversal action of the reflective surface is in a state of left circularly polarized light before reaching the retardation plate 25 again, the light is converted into 90° linearly polarized light by the retardation plate 25. The 90° linearly polarized light emitted from the retardation plate 25 is absorbed by the linear polarizing plate 22, and the light is not emitted outward. The state is visually perceived as dark.

The reflective polarizing plate 30 (see FIG. 1) has a flat plate shape and can be provided at an angle at which light that is emitted from the display surface of the reflective liquid crystal display device 20 and travels straight through the planar light source 24 is incident obliquely. Specifically, the reflective polarizing plate 30 is placed such that the incident angle of light emitted perpendicularly from the display surface of the reflective liquid crystal display device 20 is greater than 0° and less than 90°. Note that even within the range of the angle, the range where an optical path is blocked by a component included in an optical device or the like is not appropriate; thus, the angle can be greater than or equal to 20° and less than or equal to 70°, preferably greater than or equal to 30° and less than or equal to 60°, further preferably greater than or equal to 40° and less than or equal to 50°, and typically 45°. The incident angle closer to 45° facilitates the optical design such as component arrangement.

The reflective polarizing plate 30 can reflect linearly polarized light whose oscillation direction coincides with the reflection axis, and can transmit linearly polarized light whose oscillation direction is orthogonal to the reflection axis. Note that an axis orthogonal to the reflection axis is referred to as a transmission axis. The reflective polarizing plate 30 is placed such that light is incident obliquely; thus, a component that produces the above effect at the placement angle is used as the reflective polarizing plate 30. As the reflective polarizing plate 30, for example, a wire grid polarizing plate, a dielectric multilayer film, or the like can be used.

The reflective polarizing plate 30 has a function of a beam splitter and reflects or transmits incident light in accordance with the polarization state of the light.

In the direction in which light reflected by the reflective polarizing plate 30 travels, the retardation plate 41 and the half mirror 42 can be provided in this order from the reflective polarizing plate 30 side. Note that as in the above-described combination of the linear polarizing plate 22 and the retardation plate 25, the combination of the reflective polarizing plate 30 and the retardation plate 41 also serves as a circular polarizing plate.

As the half mirror 42, a metal film or a dielectric film can be used, for example. The half mirror 42 preferably has positive power for converging light reflected by the reflective polarizing plate 30 in the direction of an eye 10. Thus, the half mirror 42 preferably has a concave surface on the reflective polarizing plate 30 side. When the visible light transmittance and visible light reflectance of the half mirror 42 are denoted by T and (1-T), respectively, T can be higher than or equal to 20% and lower than or equal to 80%, and for example, T and (1-T) can each be approximately 50%. The visible light transmittance and visible light reflectance of the half mirror 42 can be selected as appropriate in accordance with an expected external light illuminance.

Although FIG. 1 illustrates an example in which adjacent components are placed to be close to each other like the retardation plate 41 and the half mirror 42, the placement of the components is not limited thereto. For example, adjacent components can be placed apart from each other. In addition, a support of a component can be provided as needed. Other components such as a lens and the like can be provided in an optical path in the electronic device.

Note that since FIG. 1 illustrates an example in which the half mirror 42 and the retardation plate 41 are placed close to each other, the retardation plate 41 also has a depressed curved surface; however, the retardation plate 41 may have a flat plate shape, for example. Note that when light can be focused in the direction of the eye 10 by a component other than the half mirror 42 included in the electronic device, the half mirror 42 can have a flat plate shape.

In the case where the above structure in which adjacent components are close to each other is employed, the components are preferably bonded to each other with the use of an optical adhesive that has high transmittance of the wavelength of light used (e.g., the wavelength range of visible light or the wavelength range from blue light to red light) and that does not cause birefringence and absorption of particular polarized light. Alternatively, another component may be formed on and in contact with one component not by bonding but by a coating method or the like. Alternatively, without using an adhesive or the like between one component and another component, the components may be placed in contact with each other. Alternatively, a space may be provided between one component and another component.

Part of light that is emitted from the reflective liquid crystal display device 20 and reflected by the reflective polarizing plate 30 is turned back by the half mirror 42, passes through the reflective polarizing plate 30, and enters the eye 10.

External light can enter from the surface opposite to the retardation plate 41 of the half mirror 42. Among the external light that passes through the retardation plate 41 and reaches the reflective polarizing plate 30, a polarizing component whose oscillation direction coincides with the transmission axis passes through the reflective polarizing plate 30 and enters the eye 10.

That is, light emitted from the display surface of the reflective liquid crystal display device 20 and external light can merge at the reflective polarizing plate 30 and enter the eye 10.

Among the external light that reaches the reflective polarizing plate 30, a polarizing component whose oscillating direction coincides with the reflection axis is reflected by the reflective polarizing plate 30 and enters the reflective liquid crystal display device 20. That is, in one embodiment of the present invention, part of external light that has entered the electronic device can be used as a light source of the reflective liquid crystal display device 20.

In conventional electronic devices, a transmissive liquid crystal display device, a self-luminous organic EL display device, or the like is often used for information display. In these display devices, when external light illuminance is high, the light intensity of information display becomes relatively weak, which causes a problem of a reduction in visibility of information display. In one embodiment of the present invention, a reflective liquid crystal device can be used for displaying information, and part of external light entering an electronic device can be made incident on the reflective liquid crystal device. Accordingly, the higher the external light illuminance is, the higher the light intensity of information display can be, thereby enabling displayed information to be viewed clearly

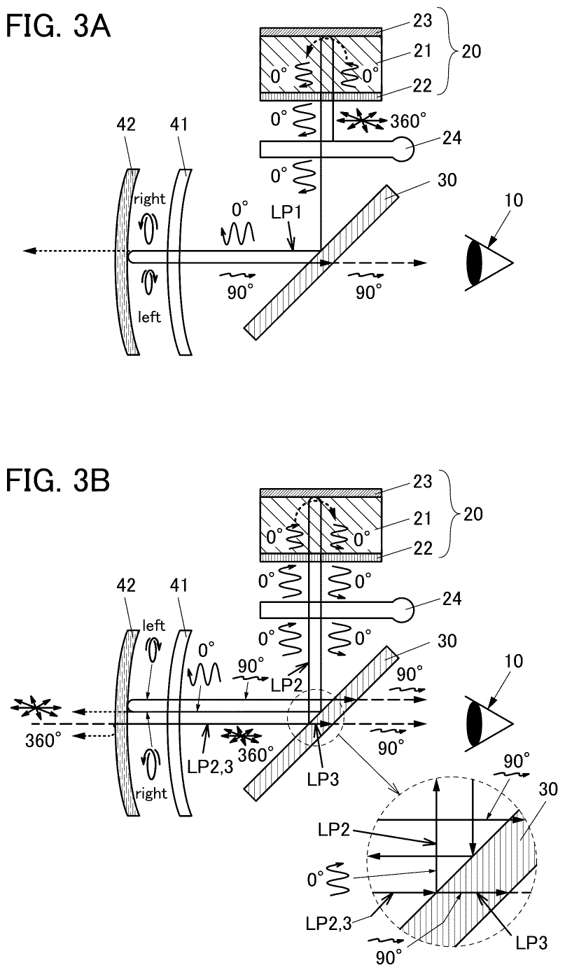

Next, polarization state and the like in an optical path in the electronic device are described in detail. FIG. 3A and FIG. 3B are cross-sectional views each illustrating an electronic device and illustrate part of an optical path. The electronic device includes an optical path LP1, an optical path LP2, and an optical path LP3.

With the planar light source 24 being the light source, the optical path LP1 is an optical path for taking into the eye 10 light that is emitted from the display surface of the reflective liquid crystal display device 20. With external light being the light source, the optical path LP2 is an optical path for taking into the eye 10 light that is emitted from the display surface of the reflective liquid crystal display device 20. LP3 is an optical path for taking external light into the eye 10. Light passing through the optical path LP1, light passing through the optical path LP2, and light passing through the optical path LP3 merge to travel to the final point the light reaches (the eye 10).

FIG. 3A illustrates the optical path LP1, and FIG. 3B illustrates the optical path LP2, the optical path LP3, and an enlarged view of part of them. FIG. 3A and FIG. 3B illustrate a state where light is emitted from the reflective liquid crystal display device 20 (a state visually perceived as bright). LP3 is established in a state where light is not emitted from the reflective liquid crystal display device 20 (a state visually perceived as dark); however, the optical path LP1 and the optical path LP2 are divided on the display surface of the reflective liquid crystal display device 20.

Note that in this specification and the like, an optical path in an electronic device refers to a path of light generated between components of the electronic device. For example, in the case where an electronic device has a structure in which light enters a component A from outside and the light exits from a component B, the optical path is a path generated between the component A and the component B, and the component A and the component B can be referred to as a starting point of the optical path and an end point of the optical path, respectively. In the case where the light source is a component of the electronic device, the light source can be referred to as a starting point of the optical path. Furthermore, the optical path from the component B to the final point that light reaches is also collectively referred to as the optical path in the electronic device in some cases.

First, the optical path LP1, which enables visual perception of display on the reflective liquid crystal display device 20 that uses the planar light source 24 as the light source, is described with reference to FIG. 3A With the planar light source 24 being the light source, light emitted from the display surface of the reflective liquid crystal display device 20 passes through the planar light source 24 and reaches the reflective polarizing plate 30. Here, the reflection axis of the reflective polarizing plate 30 is 0°, and the transmission axis is 90°. It can be said that the starting point of the optical path LP1 is the planar light source 24.

Since light emitted from the display surface of the reflective liquid crystal display device 20 is 0° linearly polarized light, the light is reflected by the reflective polarizing plate 30 whose reflective axis is 0° and passes through the retardation plate 41 to be converted into right circularly polarized light. The right circularly polarized light emitted from the retardation plate 41 is reflected by the half mirror 42, inverted to left circularly polarized light, and enters the retardation plate 41.

The left circularly polarized light incident on the retardation plate 41 is converted into 90° linearly polarized light, passes through the reflective polarizing plate 30 whose transmission axis is 90°, and enters the eye 10. Here, it can be said that the end point of the optical path LP1 is the reflective polarizing plate 30.

Next, described with reference to FIG. 3B are the optical path LP2 for enabling visual perception of display on the reflective liquid crystal display device 20 that uses external light as the light source and the optical path LP3 for enabling visual perception of external light (the outside view).

External light entering from the surface opposite to the retardation plate 41 of the half mirror 42 passes through the half mirror 42 and the retardation plate 41 and reaches the reflective polarizing plate 30. Until this point, the paths of the optical path LP2 and the optical path LP3 are common, so that it can be said that the starting point of the optical path LP2 and the optical path LP3 each is the half mirror 42.

Here, external light is unpolarized light; a component of 90° linearly polarized light whose oscillation direction coincides with the transmission axis (90°) of the reflective polarizing plate 30 is transmitted, and a component of 0° linearly polarized light whose oscillation direction coincides with the reflection axis (0°) of the reflective polarizing plate 30 is reflected.

A path in the direction in which external light passes through the reflective polarizing plate 30 is the optical path LP3, and it can be said that the end point of the optical path LP3 is the reflective polarizing plate 30. Light that passes through the reflective polarizing plate 30 can enter the eye 10.

A path in the direction in which external light is reflected by the reflective polarizing plate 30 is the optical path LP2. Light reflected by the reflective polarizing plate 30 passes through the planar light source 24 and reaches the reflective liquid crystal display device 20. Light that reaches the reflective liquid crystal display device 20 is 0° linearly polarized light, and thus passes through the 0° linearly polarized light plate, enters the liquid crystal layer 21, and is turned back by the reflective layer while subjected to optical modulation action of the liquid crystal. On the assumption that the light is in a state perceived as bright, the light passes through the 0° linear polarizing plate and the plane light source 24 in a state of 0° linearly polarized light and reaches the reflective polarizing plate 30.

After that, through a similar process to that of the optical path LP1, the light reaches the reflective polarizing plate 30 again and enters the eye 10. Therefore, it can be said that the end point of the optical path LP2 is the reflective polarizing plate 30.

The optical path LP1, the optical path LP2, and the optical path LP3 can merge at an end point or in a path before the end point, and images composed of light passing through the optical paths can be superimposed on each other. The most significant effect of one embodiment of the present invention is to increase visibility of display on the reflective liquid crystal display device 20 by merging the optical path LP1 and the optical path LP2.

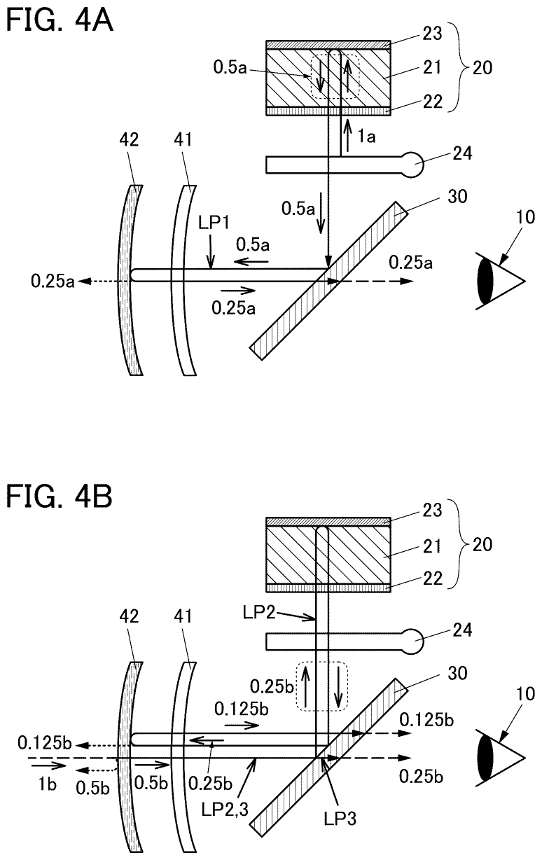

Next, light utilization efficiency in each optical path is described with reference to FIG. 4A and FIG. 4B. Note that the light utilization efficiency described here is an ideal state, and unclear reflection and absorption of light by a surface and collapse of polarized light in each component of the electronic device are ignored here. In addition, in the reflective liquid crystal display device 20, the aperture ratio is 100%, and loss due to a light-blocking layer or the like is ignored.

In the reflective liquid crystal display device 20, the transmittance at the time when unpolarized light enters the linear polarizing plate 22 is 50%, the transmittance of polarized light corresponding to the transmission axis is 100%, and the reflectance of the reflective layer 23 is 100%.

The reflectance and the transmittance at the time when unpolarized light enters the reflective polarizing plate 30 and the transmittance and reflectance of the half mirror 42 are each 50%.

The transmittance of the planar light source 24 and the retardation plate 41, the reflectance of polarized light corresponding to the reflection axis of the reflective polarizing plate 30, and the transmittance of polarized light corresponding to the transmission axis thereof are each 100%.

First, the light utilization efficiency in the optical path LP1 is described with reference to FIG. 4A. Note that numerical values shown in the drawing represent relative values at each position when the effective amount of light incident on the reflective liquid crystal display device 20 from the planar light source 24 is 1a.

Since effective light (the amount of light 1a) emitted from the planar light source 24 to the reflective liquid crystal display device 20 is unpolarized light, the amount of light that passes through the linear polarizing plate 22 becomes 50%, i.e., 0.5a. After that, the light is reflected by the reflective layer 23, passes through the linear polarizing plate 22 and the planar light source 24, and reaches the reflective polarizing plate 30, with the amount of light maintained.

The light is reflected by the reflective polarizing plate 30 without loss, passes through the retardation plate 41, and is reflected by the half mirror 42. At this time, since the reflectance of the half mirror 42 is 50%, the amount of light is attenuated to 0.25a. After that, the light passes through the retardation plate 41 and the reflective polarizing plate 30 without loss. Thus, the amount of light reaching the eye 10 is 0.25a.

Next, the light utilization efficiency in the optical path LP2 and the optical path LP3 is described with reference to FIG. 4B. Note that the numerical values shown in the drawing represent relative values at each position when the amount of effective external light incident on the half mirror 42 is 1b.

First, external light (the amount of light 1b) enters the half mirror 42. At this time, since the transmittance of the half mirror 42 is 50%, the amount of light is attenuated to 0.5b. Then, the light passes through the retardation plate 41 and reaches the reflective polarizing plate 30.

Since the light passing through the retardation plate 41 is unpolarized light, the amount of light that passes through the reflective polarizing plate 30 becomes 50%, i.e., 0.25b. That is, the amount of external light reaching the eye 10 through the optical path LP3 is 0.25b.

Furthermore, the amount of light reflected by the reflective polarizing plate 30 also becomes 50%, i.e., 0.25b; the light passes through the planar light source, is turned back by the reflective liquid crystal display device 20, passes through the planar light source again, and reaches the reflective polarizing plate 30, with the amount of light maintained.

The light is reflected by the reflective polarizing plate 30 without loss, passes through the retardation plate 41, and is reflected by the half mirror 42. At this time, since the reflectance of the half mirror 42 is 50%, the amount of light is attenuated to 0.125b. After that, the light passes through the retardation plate 41 and the reflective polarizing plate 30 without loss. Accordingly, the amount of light reaching the eye 10 through the optical path LP2 is 0.125b.

Therefore, the amount of light reaching the eye 10 as external light (the outside view) becomes 0.25b. The amount of light reaching the eye 10 as display of the reflective liquid crystal display device 20 is 0.25a+0.125b.

Here, it can be said that the amount of external light is larger than the amount of light of the planar light source 24 (b>a) at a high illuminance such as outdoors; thus, the amount of light reaching the eye 10 as display of the reflective liquid crystal display device 20 becomes larger than at least 0.25a+0.125a=0.375a. This means that the visibility of display can be increased because the amount of light is 0.25a in the case where only the planar light source 24 is used as the light source.

Even at a low illuminance, the amount of light of the planar light source 24 can be reduced in some cases because the amount of light reaching the eye 10 as display of the reflective liquid crystal display device 20 can be supplemented with external light equivalent to 0.125b. In other words, the power consumption of the planar light source 24 can be reduced.

Next, an electronic device with a structure different from that of the electronic device illustrated in FIG. 1 is described with reference to FIG. 5 to FIG. 9.

FIG. 5 is a perspective view illustrating an electronic device of one embodiment of the present invention different from that in FIG. 1. It is different from the structure illustrated in FIG. 1 in the structure and the position of the planar light source, the transmission axis of the linear polarizing plate 22, and the placement of a linear polarizing plate 28.

A planar light source 27 is provided such that its light-emitting surface faces the display surface of the reflective liquid crystal display device 20 with the reflective polarizing plate 30 therebetween. The linear polarizing plate 28 is provided on the light-emitting surface side of the planar light source 27. Note that in the case where the planar light source 27 is placed in the position illustrated in FIG. 5, display on the reflective liquid crystal display device 20 can be visually perceived without through the planar light source 27.

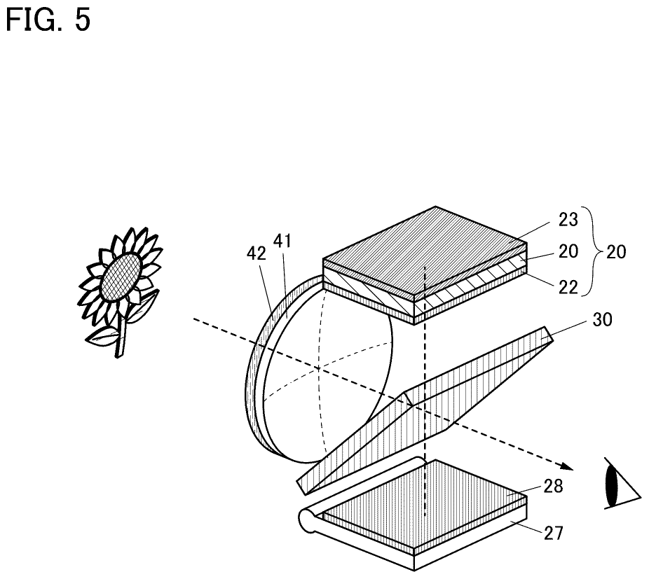

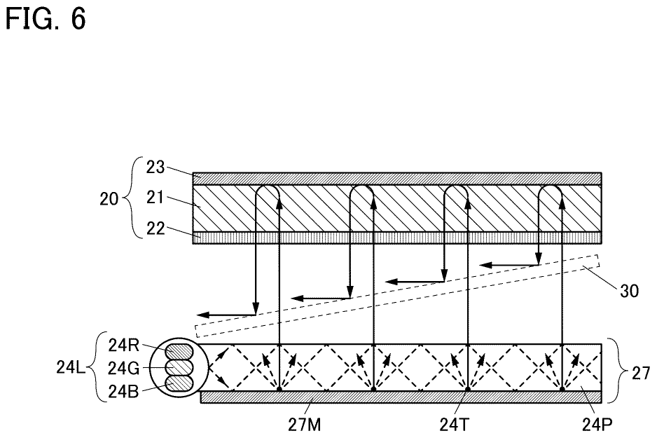

Accordingly, the planar light source 27 does not need a light-transmitting property in the thickness direction; thus, a reflective layer 27M can be provided on the opposite surface of the light-emitting surface as illustrated in FIG. 6. Furthermore, the degree of freedom in the arrangement position, the kind, the density, and the like of the trigger 24T can be increased. Therefore, the emission intensity can be increased. For example, the planar light source 27 can have a structure equivalent to that of an edge-type backlight used for a transmissive liquid crystal display device or the like or a direct-below backlight in which the light-emitting sources 24L are arranged on a plane. Note that the light-emitting source 24L preferably includes individual light-emitting sources of RGB as in the planar light source 24.

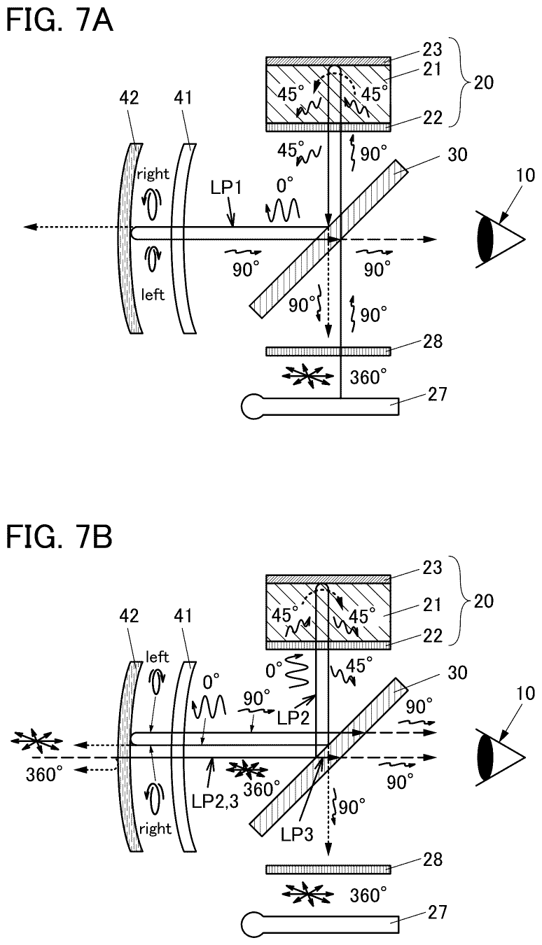

Next, the polarization state and the like in an optical path in the electronic device illustrated in FIG. 5 are described in detail. FIG. 7A and FIG. 7B are cross-sectional views illustrating the electronic device and illustrate part of an optical path. Note that the transmission axis of the linear polarizing plate 22 is 45° and the transmission axis of the linear polarizing plate 28 is 90°.

First, the optical path LP1, which enables visual perception of display on the reflective liquid crystal display device 20 that uses the planar light source 27 as the light source, is described with reference to FIG. 7A.

Light (unpolarized light) emitted from the light-emitting surface of the planar light source 27 reaches the linear polarizing plate 28, and a component of 90° linearly polarized light passes through the linear polarizing plate 28. The light emitted from the linear polarizing plate 28 passes through the reflective polarizing plate 30 whose transmission axis is 90°, and a component of 45° linearly polarized light passes through the linear polarizing plate 22. Then, the light is turned back by the reflective layer while subjected to optical modulation of the liquid crystal. On the assumption that the light is in a state perceived as bright, the light passes through the liquid crystal layer 21 and the linear polarizing plate 22 and reaches the reflective polarizing plate 30 while in a state of 45° linearly polarized light.

A component of 0° linearly polarized light is reflected by the reflective polarizing plate 30 whose reflective axis is 0° and passes through the retardation plate 41 to be converted into right circularly polarized light. The right circularly polarized light emitted from the retardation plate 41 is reflected by the half mirror 42, inverted to left circularly polarized light, and enters the retardation plate 41.

The left circularly polarized light incident on the retardation plate 41 is converted into 90° linearly polarized light, passes through the reflective polarizing plate 30 whose transmission axis is 90°, and enters the eye 10. Here, it can be said that the end point of the optical path LP1 is the reflective polarizing plate 30.

Next, described with reference to FIG. 7B is the optical path LP2 for enabling visual perception of display on the reflective liquid crystal display device 20 that uses external light as the light source and the optical path LP3 for enabling visual perception of external light (the outside view).

External light entering from the surface of the half mirror 42 opposite to the surface provided with the retardation plate 41 passes through the half mirror 42 and the retardation plate 41 and reaches the reflective polarizing plate 30. Until this point, the paths of the optical path LP2 and the optical path LP3 are common, so that it can be said that the starting point of the optical path LP2 and the optical path LP3 each is the half mirror 42.

Here, external light is unpolarized light; a component of 90° linearly polarized light whose oscillation direction coincides with the transmission axis (90°) of the reflective polarizing plate 30 is transmitted, and a component of 0° linearly polarized light whose oscillation direction coincides with the reflection axis (0°) of the reflective polarizing plate 30 is reflected.

A path in the direction in which external light passes through the reflective polarizing plate 30 is the optical path LP3, and it can be said that the end point of the optical path LP3 is the reflective polarizing plate 30. Light that passes through the reflective polarizing plate 30 can enter the eye 10.

A path in the direction in which external light is reflected by the reflective polarizing plate 30 is the optical path LP2. Light reflected by the reflective polarizing plate 30 reaches the reflective liquid crystal display device 20. Light reaching the reflective liquid crystal display device 20 is 0° linearly polarized light, and a component of 45° linearly polarized light that passes through the linear polarizing plate 22 enters the liquid crystal layer 21 and is turned back by the reflective layer while subjected to optical modulation action of the liquid crystal. On the assumption that the light is in a state perceived as bright, the light passes through the linear polarizing plate 22 in a state of 45° linearly polarized light and reaches the reflective polarizing plate 30.

After that, through a process similar to that of the optical path LP1, the light reaches the reflective polarizing plate 30 again and enters the eye 10. Therefore, it can be said that the end point of the optical path LP2 is the reflective polarizing plate 30.

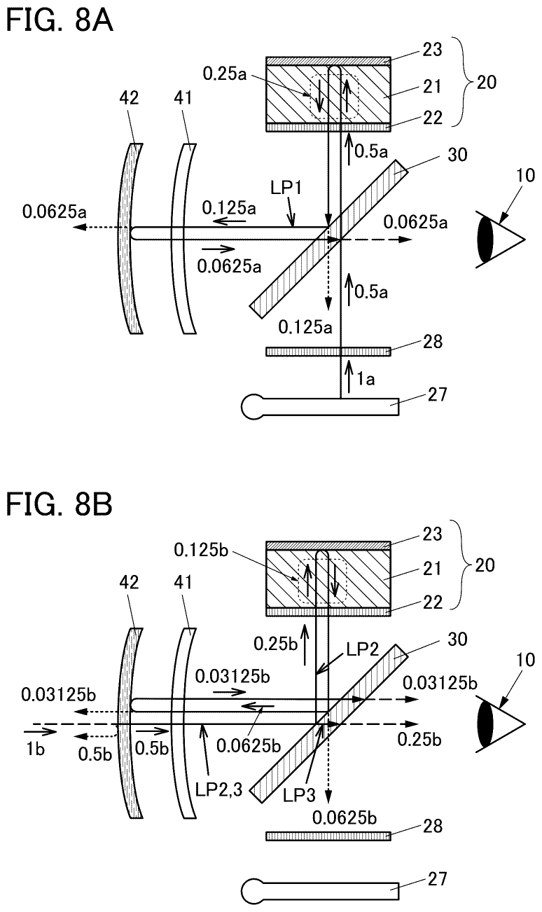

Next, light utilization efficiency in each optical path is described with reference to FIG. 8A and FIG. 8B. Note that the light utilization efficiency described here is an ideal state, and unclear reflection and absorption of light by a surface and collapse of polarized light in each component of the electronic device are ignored here. In addition, in the reflective liquid crystal display device 20, the aperture ratio is 100%, and loss due to a light-blocking layer or the like is ignored. The reflectance and the transmittance of each component have the same values as those used for the description of FIG. 4A and FIG. 4B, and components with different values will be explained accordingly First, the light utilization efficiency of the optical path LP1 is described with reference to FIG. 8A. Note that numerical values shown in the drawing represent relative values at each position when the effective amount of light incident on the linear polarizing plate 28 from the planar light source 27 is 1a.

Since effective light (the amount of light 1a) emitted from the planar light source 27 to the linear polarizing plate 28 is unpolarized light, the amount of light that passes through the linear polarizing plate 28 becomes 50%, i.e., 0.5a. After that, the light passes through the reflective polarizing plate 30 and reaches the linear polarizing plate 22 of the reflective liquid crystal display device 20, with the amount of light maintained.

Since the light that reaches the linear polarizing plate 22 is 90° linearly polarized light and the transmission axis of the linear polarizing plate 22 is 45°, the amount of transmitted light is the product of the amount of incident light and 0.5, which corresponds to the vector component. That is, since the amount of 90° linearly polarized light incident on the linear polarizing plate 22 is 0.5a, the amount of light that passes through the linear polarizing plate 22 becomes 0.25a.

Since the light that reaches the reflective polarizing plate 30 is 45° linearly polarized light and the transmission axis of the reflective polarizing plate 30 is 0°, the amount of transmitted light is the product of the amount of incident light and 0.5, which corresponds to the vector component. That is, since the amount of 45° linearly polarized light incident on the reflective polarizing plate 30 is 0.25a, the amount of light reflected by the reflective polarizing plate 30 becomes 0.125a.

The light reflected by the reflective polarizing plate 30 passes through the retardation plate 41 and is reflected by the half mirror 42. At this time, since the reflectance of the half mirror 42 is 50%, the amount of light is attenuated to 0.0625a. After that, the light passes through the retardation plate 41 and the reflective polarizing plate 30 without loss. Accordingly, the amount of light reaching the eye 10 is 0.0625a.

Next, the light utilization efficiency in the optical path LP2 and the optical path LP3 is described with reference to FIG. 8B. Note that the numerical values shown in the drawing represent relative values at each position when the amount of effective external light incident on the half mirror 42 is 1b.

First, external light (the amount of light 1b) enters the half mirror 42. At this time, since the transmittance of the half mirror 42 is 50%, the amount of light is attenuated to 0.5b. Then, the light passes through the retardation plate 41 and reaches the reflective polarizing plate 30.

Since the light passing through the retardation plate 41 is unpolarized light, the amount of light that passes through the reflective polarizing plate 30 becomes 50%, i.e., 0.25b. That is, the amount of external light reaching the eye 10 through the optical path LP3 is 0.25b.

Furthermore, the amount of light reflected by the reflective polarizing plate 30 also becomes 50%, i.e., 0.25b, and the light reaches the linear polarizing plate 22 of the reflective liquid crystal display device 20.

Since the light that reaches the linear polarizing plate 22 is 0° linearly polarized light and the transmission axis of the linear polarizing plate 22 is 45°, the amount of transmitted light is the product of the amount of incident light and 0.5, which corresponds to the vector component. That is, since the amount of 0° linearly polarized light incident on the linear polarizing plate 22 is 0.25b, the amount of light that passes through the linear polarizing plate 22 becomes 0.125b.

Since the light that reaches the reflective polarizing plate 30 is 45° linearly polarized light and the reflection axis of the reflective polarizing plate 30 is 0°, the amount of reflected light is the product of the amount of incident light and 0.5, which corresponds to the vector component. That is, since the amount of 45° linearly polarized light incident on the reflective polarizing plate 30 is 0.125b, the amount of light reflected by the reflective polarizing plate 30 becomes 0.0625b.

The light reflected by the reflective polarizing plate 30 passes through the retardation plate 41 and is reflected by the half mirror 42. At this time, since the reflectance of the half mirror 42 is 50%, the amount of light is attenuated to 0.03125b. After that, the light passes through the retardation plate 41 and the reflective polarizing plate 30 without loss. Accordingly, the amount of light reaching the eye 10 through the optical path LP2 is 0.03125b.

Accordingly, the amount of light reaching the eye 10 as external light (the outside view) is 0.25. The amount of light reaching the eye 10 as display of the reflective liquid crystal display device 20 is 0.0625a+0.03125b.

Here, it can be said that the amount of external light is larger than the amount of light of the planar light source 27 (b>a) at a high illuminance such as outdoors; thus, the amount of light reaching the eye 10 as display of the reflective liquid crystal display device 20 becomes larger than at least 0.0625a+0.03125a=0.09375a. This means that the visibility of display can be increased because the amount of light is 0.0625a in the case where only the planar light source 27 is used as the light source.

Even at a low illuminance, the amount of light of the planar light source 27 can be reduced in some cases because the amount of light reaching the eye 10 as display of the reflective liquid crystal display device 20 can be supplemented with external light equivalent to 0.03125b. Accordingly, the power consumption of the planar light source 27 can be reduced.

Note that as illustrated in FIG. 9, the planar light source 24 described in FIG. 2A can be used as the planar light source. In this case, since the planar light source 24 can transmit light in the thickness direction, external light can be made incident from the surface opposite to the light-emitting surface, whereby the external light can be used as display light for the reflective liquid crystal display device 20.

It can be said that the optical path illustrated in FIG. 9 is the same as LP1. Thus, the description of FIG. 7A and FIG. 8A can be referred to; when the effective amount of light that passes through the planar light source 24 and enters the linear polarizing plate 28 is 1c, the amount of display light reaching the eye 10 from the reflective liquid crystal display device 20 becomes 0.0625c.

As shown in FIG. 8A, FIG. 8B, and FIG. 9, the amount of light reaching the eye 10 as external light (the outside view) becomes 0.25b. The amount of light reaching the eye 10 as display of the reflective liquid crystal display device 20 is 0.0625a+0.03125b+0.0625c.

Here, it can be said that the amount of external light is larger than the amount of light of the planar light source 27 (b>a, c>a) at a high illuminance; thus, the amount of light reaching the eye 10 as display of the reflective liquid crystal display device 20 becomes larger than at least 0.0625a+0.03125a+0.0625a=0.15625a. This means that the visibility of display can be increased because the amount of light is 0.0625a in the case where only the planar light source 27 is used as the light source.

Even at a low illuminance, the amount of light of the planar light source 27 can be reduced in some cases because the amount of light reaching the eye 10 as display of the reflective liquid crystal display device 20 can be supplemented with external light equivalent to 0.03125b+0.0625c. Accordingly, the power consumption of the planar light source 27 can be reduced.

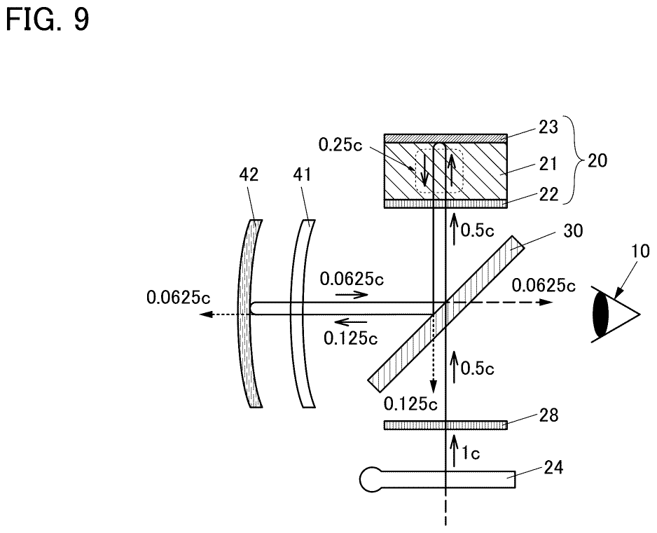

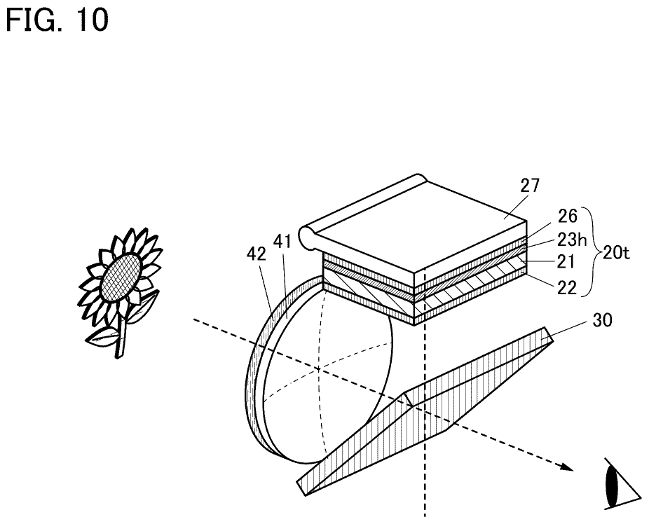

Next, an electronic device with a structure different from that of the electronic device illustrated in FIG. 1 and FIG. 2 is described with reference to FIG. 10 to FIG. 14.

FIG. 10 is a perspective view illustrating an electronic device of one embodiment of the present invention different from that in FIG. 1 and FIG. 2. It is different from the structures illustrated in FIG. 1 and FIG. 2 in that a transflective liquid crystal display device 20t is used.

The transflective liquid crystal display device 20t includes the liquid crystal layer 21, the linear polarizing plate 22, a transflective layer 23h, and a linear polarizing plate 26. The liquid crystal layer 21 is provided between the linear polarizing plate 22 and the transflective layer 23h, and the user visually perceives light emitted from the linear polarizing plate 22 in accordance with optical modulation of the liquid crystal. Thus, in the transflective liquid crystal display device 20t, a surface provided with the linear polarizing plate 22 or a surface of the linear polarizing plate 22 is referred to as a display surface. Furthermore, the linear polarizing plate 26 is provided on the surface opposite to the display surface. Note that FIG. 10 simply illustrates the transflective liquid crystal display device 20t; in the actual structure, the transflective layer 23h is a pixel electrode and is provided for each pixel. The detailed structure of the transflective liquid crystal display device is described later in the other embodiment.

The plane light source 27 can be provided at a position where the light-emitting surface faces the linear polarizing plate 26. The transflective liquid crystal display device 20t can perform both operation as a transmissive liquid crystal display device using the planar light source 27 as the light source and operation as a reflective liquid crystal display device using external light as the light source.

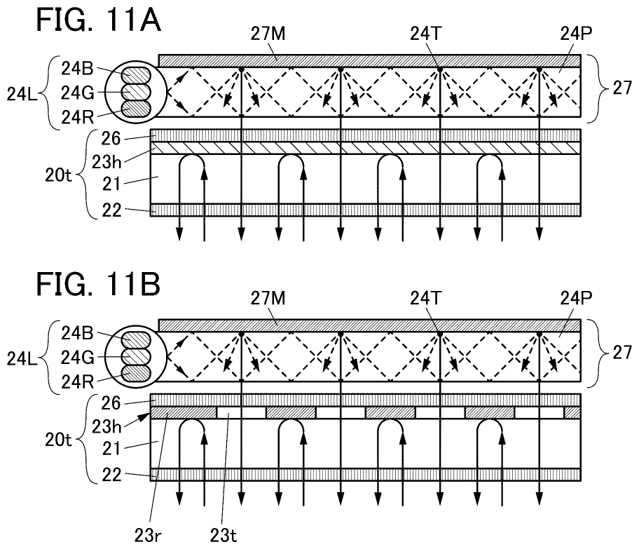

FIG. 11A is a cross-sectional view illustrating a concept of the transflective liquid crystal display device 20t and the planar light source 27. For the transflective layer 23h, for example, a half mirror whose transmittance and reflectance are each 50% can be used. Thus, in the case where external light illuminance is sufficiently high, the transflective liquid crystal display device 20t can operate as a reflective liquid crystal display device. At this time, the planar light source 27 may be in an off state. In the case where external light illuminance is low, the transflective liquid crystal display device 20t can operate as a transmissive liquid crystal display device.

Note that the transflective layer 23h is not limited to the above-described half mirror type and may include a reflective layer 23r and a light-transmitting layer 23t as illustrated in FIG. 11B. A region provided with the reflective layer 23r functions as a reflective liquid crystal display device, and a region provided with the light-transmitting layer 23t functions as a transmissive liquid crystal display device. Note that the light-transmitting layer 23t includes a light-transmitting conductive layer, and the light-transmitting conductive layer functions as a pixel electrode.

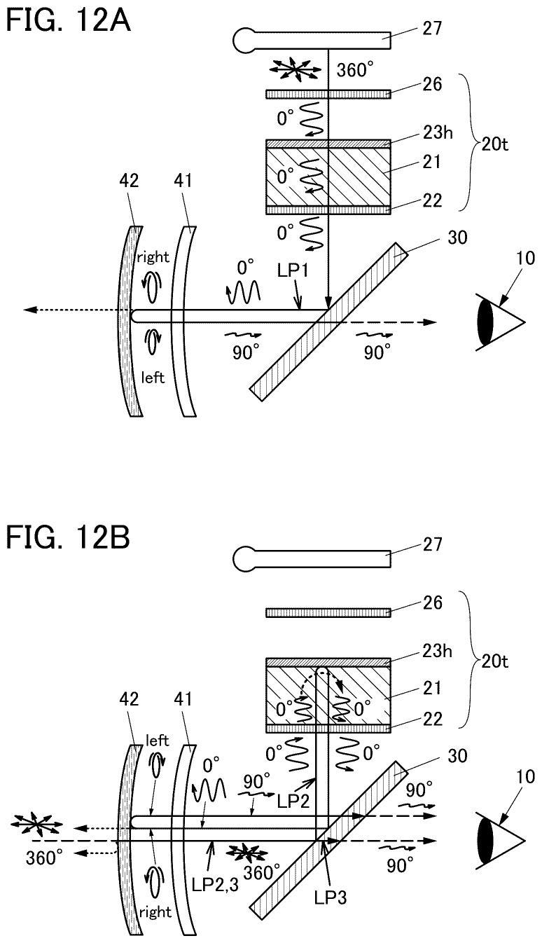

Next, the polarization state and the like in an optical path in the electronic device illustrated in FIG. 10 are described in detail. FIG. 12A and FIG. 12B are cross-sectional views illustrating the electronic device and illustrate part of an optical path. The electronic device includes the optical path LP1, the optical path LP2, and the optical path LP3.

First, the optical path LP1, which enables visual perception of display on the reflective liquid crystal display device 20t that uses the planar light source 27 as the light source, is described with reference to FIG. 12A. Note that the transmission axis of the linear polarizing plate 26 is 0°.

Light (unpolarized light) emitted from the light-emitting surface of the planar light source 27 reaches the linear polarizing plate 26, and a component of 0° linearly polarized light passes through the linear polarizing plate 26. Light emitted from the linear polarizing plate 26 passes through the transflective layer 23h, and on the assumption that the light is in a state perceived as bright, the light passes through the liquid crystal layer 21 and the linear polarizing plate 22. Here, it can be said that the starting point of the optical path LP1 is the planar light source 27.

Since light reaching the reflective polarizing plate 30 is 0° linearly polarized light, the light is reflected by the reflective polarizing plate 30 whose reflective axis is 0° and passes through the retardation plate 41 to be converted into right circularly polarized light. The right circularly polarized light emitted from the retardation plate 41 is reflected by the half mirror 42, inverted to left circularly polarized light, and enters the retardation plate 41.

The left circularly polarized incident on the retardation plate 41 is converted into 90° linearly polarized light, passes through the reflective polarizing plate 30 whose transmission axis is 90°, and enters the eye 10. Here, it can be said that the end point of the optical path LP1 is the reflective polarizing plate 30.

Next, described with reference to FIG. 12B is the optical path LP2 for enabling visual perception of display on the transflective liquid crystal display device 20t that uses external light as the light source and the optical path LP3 for enabling visual perception of external light (the outside view).

External light entering from the surface of the half mirror 42, which is opposite to the retardation plate 41 side, passes through the half mirror 42 and the retardation plate 41 and reaches the reflective polarizing plate 30. Until this point, the path is common for the optical path LP2 and the optical path LP3, so that it can be said that the starting point of the optical path LP2 and the optical path LP3 is the half mirror 42.

Here, external light is unpolarized light; a component of 90° linearly polarized light whose oscillation direction coincides with the transmission axis (90°) of the reflective polarizing plate 30 is transmitted, and a component of 0° linearly polarized light whose oscillation direction coincides with the reflection axis (0°) of the reflective polarizing plate 30 is reflected.

A path in the direction in which external light passes through the reflective polarizing plate 30 is the optical path LP3, and it can be said that the end point of the optical path LP3 is the reflective polarizing plate 30. Light that passes through the reflective polarizing plate 30 can enter the eye 10.

A path in the direction in which external light is reflected by the reflective polarizing plate 30 is the optical path LP2. Light reflected by the reflective polarizing plate 30 reaches the transflective liquid crystal display device 20t. Light that reaches the transflective liquid crystal display device 20 t is 0° linearly polarized light, and thus passes through the linear polarizing plate 22 and is turned back by the transflective layer 23h while subjected to optical modulation action of the liquid crystal. On the assumption that the light is in a state perceived as bright, the light passes through the linear polarizing plate 22 in the state of 0° linearly polarized light and reaches the reflective polarizing plate 30.

After that, through a process similar to that of the optical path LP1, the light reaches the reflective polarizing plate 30 again and enters the eye 10. Therefore, it can be said that the end point of the optical path LP2 is the reflective polarizing plate 30.

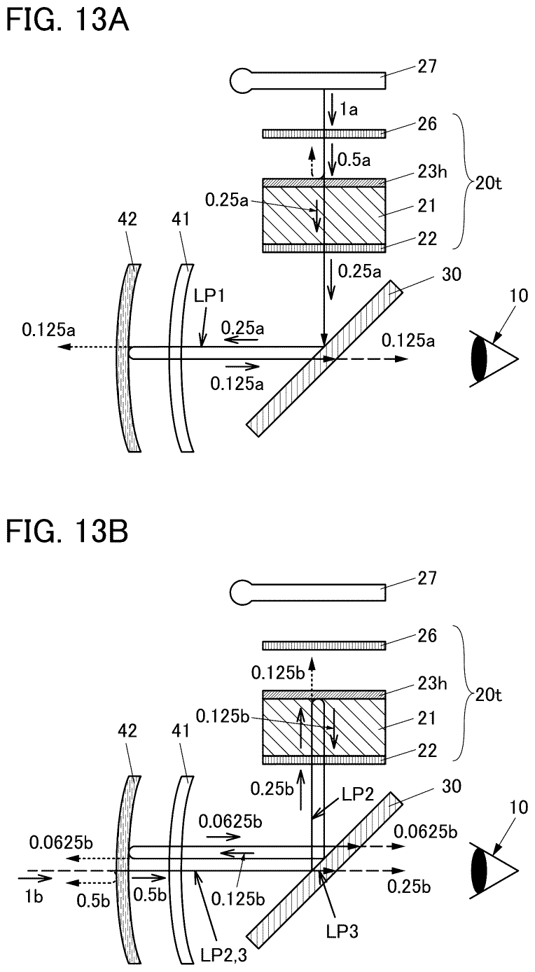

Next, light utilization efficiency in each optical path is described with reference to FIG. 13A and FIG. 13B. Note that the light utilization efficiency described here is an ideal state, and unclear reflection and absorption of light by a surface and collapse of polarized light in each component of the electronic device are ignored here. In addition, in the transflective liquid crystal display device 20t, the aperture ratio is 100%, and loss due to a light-blocking layer or the like is ignored. The reflectance and the transmittance of each component are the same as the values used in the description of FIG. 4A and FIG. 4B, and the transmittance and reflectance of the transflective layer 23h are each 50%.

First, the light utilization efficiency in the optical path LP1 is described with reference to FIG. 13A. Note that numerical values shown in the drawing represent relative values at each position when the effective amount of light incident on the linear polarizing plate 26 from the planar light source 27 is 1a.

Since effective light (the amount of light 1a) emitted from the planar light source 27 to the linear polarizing plate 26 is unpolarized light, the amount of light that passes through the linear polarizing plate 26 becomes 50%, i.e., 0.5a. After that, the amount of light is attenuated to 0.25a by the transflective layer 23h whose transmittance is 50% and reaches the reflective polarizing plate 30.

The light reflected by the reflective polarizing plate 30 passes through the retardation plate 41 and is reflected by the half mirror 42. At this time, since the reflectance of the half mirror 42 is 50%, the amount of light is attenuated to 0.125a. After that, the light passes through the retardation plate 41 and the reflective polarizing plate 30 without loss. Accordingly, the amount of light reaching the eye 10 is 0.125a.

Next, the light utilization efficiency in the optical path LP2 and the optical path LP3 is described with reference to FIG. 13B. Note that the numerical values shown in the drawing represent relative values at each position when the effective amount of external light incident on the half mirror 42 is 1b.

First, external light (the amount of light 1b) enters the half mirror 42. At this time, since the transmittance of the half mirror 42 is 50%, the amount of light is attenuated to 0.5b. Then, the light passes through the retardation plate 41 and reaches the reflective polarizing plate 30.

Since the light passing through the retardation plate 41 is unpolarized light, the amount of light that passes through the reflective polarizing plate 30 becomes 50%, i.e., 0.25b. That is, the amount of external light reaching the eye 10 through the optical path LP3 is 0.25b.

Furthermore, the amount of light reflected by the reflective polarizing plate 30 also becomes 50%, i.e., 0.25b, and the light reaches the linear polarizing plate 22 of the transflective liquid crystal display device 20t.

Light reaching the linear polarizing plate 22 is 0° linearly polarized light, and passes through the linear polarizing plate 22 and is reflected by the transflective layer 23h. At this time, since the reflectance of the transflective layer 23h is 50%, the amount of light is attenuated to 0.125b, and the light reaches the reflective polarizing plate 30.

The light reflected by the reflective polarizing plate 30 passes through the retardation plate 41 and is reflected by the half mirror 42. At this time, since the reflectance of the half mirror 42 is 50%, the amount of light is attenuated to 0.0625b. After that, the light passes through the retardation plate 41 and the reflective polarizing plate 30 without loss. Accordingly, the amount of light reaching the eye 10 through the optical path LP3 is 0.0625b.

Accordingly, the amount of light reaching the eye 10 as external light (the outside view) becomes 0.25b. The amount of light reaching the eye 10 as display of the transflective liquid crystal display device 20t becomes 0.125a+0.0625b

Here, it can be said that the amount of external light is larger than the amount of light of the planar light source 27 (b>a) at a high illuminance; thus, the amount of light reaching the eye 10 as display of the transflective liquid crystal display device 20t becomes larger than at least 0.125a+0.0625a=0.1875a. This means that the visibility of display can be increased, since the amount of light is 0.125a in the case where only the planar light source 27 is used as the light source.

Even at a low illuminance, the amount of light of the planar light source 27 can be reduced in some cases because the amount of light reaching the eye 10 as display of the reflective liquid crystal display device 20 can be supplemented with external light equivalent to 0.0625b. Thus, the power consumption of the planar light source 27 can be reduced.

Note that as illustrated in FIG. 14, the planar light source 24 described in FIG. 2A can also be used as the planar light source. In this case, since the planar light source 24 can transmit light in the thickness direction, external light can be made incident from the surface opposite to the light-emitting surface, whereby the external light can be used as display light for the transflective liquid crystal display device 20t.

It can be said that the optical path illustrated in FIG. 14 is the same as LP1. Thus, the description of FIG. 12A and FIG. 13A can be referred to; when the effective amount of light that passes through the planar light source 24 and enters the linear polarizing plate 26 is 1c, the amount of display light from the transflective liquid crystal display device 20t reaching the eye 10 becomes 0.125c.

According to FIG. 13A, FIG. 13B, and FIG. 14, the amount of light reaching the eye 10 as external light (the outside view) becomes 0.25b. The amount of light reaching the eye 10 as display of the transflective liquid crystal display device 20t becomes 0.125a+0.0625b+0.125c.

Here, it can be said that the amount of external light is larger than the amount of light of the planar light source 27 (b>a, c>a) under a high illuminance condition; thus, the amount of light reaching the eye 10 as display of the transflective liquid crystal display device 20t becomes larger than at least 0.125a+0.0625a+0.125a=0.3125a. This means that the visibility of display can be increased, since the amount of light is 0.125a in the case where only the planar light source 27 is used as the light source.

Even at a low illuminance, the amount of light of the planar light source 27 can be reduced in some cases because the amount of light reaching the eye 10 as display of the reflective liquid crystal display device 20 can be supplemented with external light equivalent to 0.0625b+0.125c. Thus, the power consumption of the planar light source 27 can be reduced.

Note that for the electronic device illustrated in each of FIG. 1, FIG. 5, and FIG. 10, a structure in which the shape, position, or the like of one or more components is changed is employed in some cases in consideration of being incorporated in a housing of the electronic device, for example. In such a case, another component may be added such that light passing through each of the optical path LP1 and the optical path LP2 forms an image at the same position.

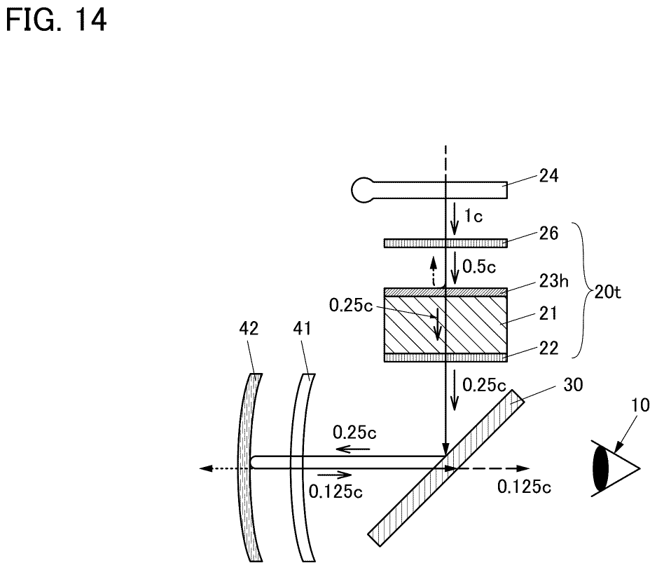

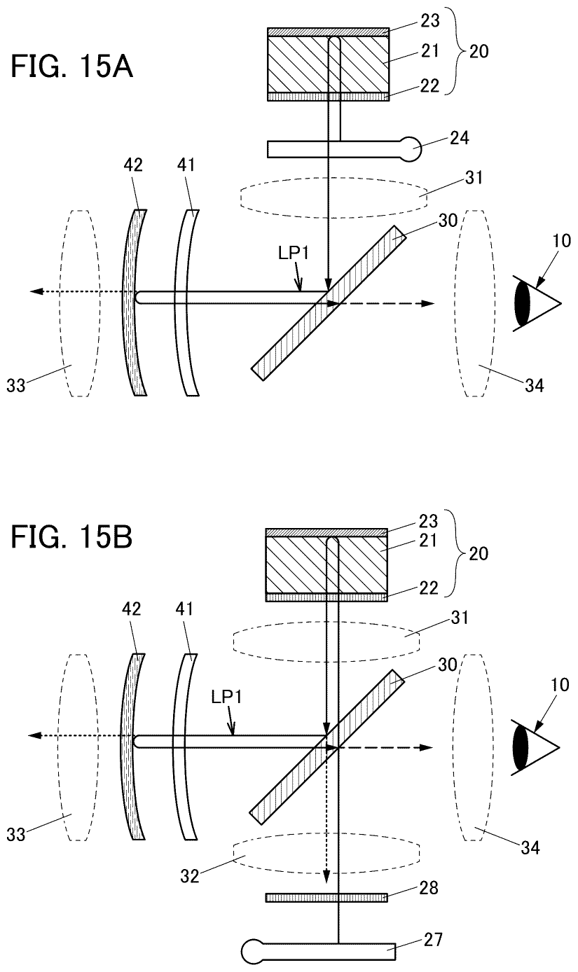

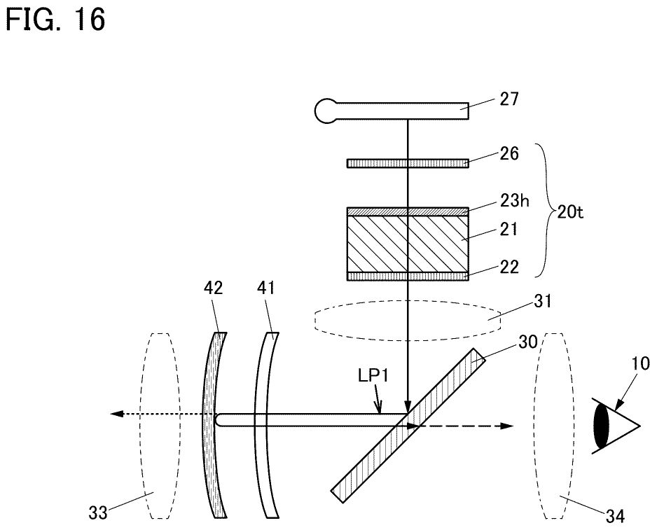

For example, in the electronic device illustrated in FIG. 1, a lens 31 can be provided between the planar light source 24 and the reflective polarizing plate 30 as illustrated in FIG. 15A. Moreover, in the electronic device illustrated in FIG. 5, the lens 31 can be provided between the reflective liquid crystal display device 20 and the reflective polarizing plate 30 as illustrated in FIG. 15B. Alternatively, a lens 32 can be provided between the reflective polarizing plate 30 and the linear polarizing plate 28. In the electronic device illustrated in FIG. 10, the lens 31 can be provided between the transflective liquid crystal display device 20t and the reflective polarizing plate 30 as illustrated in FIG. 16.

Note that it is preferable that no lens be provided between the reflective polarizing plate 30 and the retardation plate 41. While adjustments of the optical path LP1 and the optical path LP2 are possible when a lens is placed in the position, unintended change is caused in the optical path LP3. Note that a lens 33 can be provided outside the half mirror 42. Since the position does not affect the optical path LP1 and the optical path LP2, the lens 33 functions as a visibility adjustment lens which adjusts only the external light that is taken in. As a lens that also has a function of visibility adjustment, a lens 34 can also be provided on the light emission side after the optical path LP1, the optical path LP2, and the optical path LP3 are merged. In addition, a lens that also has a function of visibility adjustment can be provided between the reflective polarizing plate 30 and the retardation plate 41.

Although FIG. 15A, FIG. 15B, and FIG. 16 each illustrate an example in which a biconvex lens is used for each lens, one embodiment of the present invention is not limited thereto. For example, each of the lenses may be formed of a plurality of biconvex lenses. Alternatively, a plano-convex lens may be used for each of the lenses. Alternatively, each of the lenses can be formed by combining lenses selected from a biconvex lens, a plano-convex lens, a biconcave lens, a plano-concave lens, a convex meniscus lens, and a concave meniscus lens. Furthermore, each of the lenses is not limited to a spherical lens and may be an aspherical lens. Each of the lenses may have different forms.

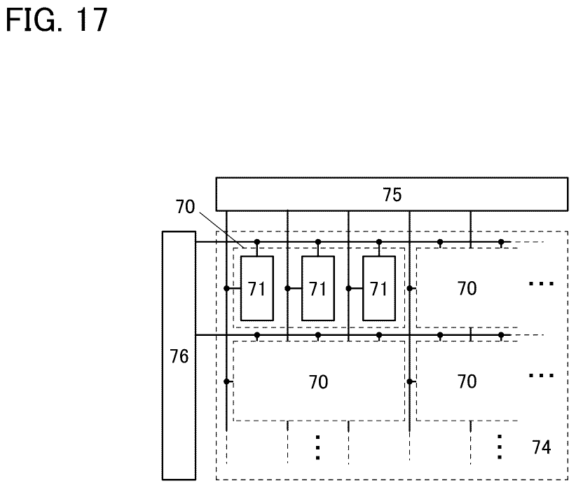

FIG. 17 is a block diagram illustrating a display device corresponding to the reflective liquid crystal display device 20 or the transflective liquid crystal display device 20t included in the electronic device of one embodiment of the present invention. The display device includes a pixel array 74, a circuit 75, and a circuit 76. The pixel array 74 includes pixels 70 arranged in a column direction and a row direction.

The pixel 70 can include a plurality of subpixels 71. The subpixels 71 include liquid crystal elements and have a function of emitting light for display by utilizing light incident from a light source. When color filters of R (red), G (green), B (blue), and the like are provided for the subpixels 71, full-color display can be performed.

The circuit 75 and the circuit 76 are driver circuits for driving the subpixels 71. The circuit 75 can have a function of a source driver circuit, and the circuit 76 can have a function of a gate driver circuit. A shift register circuit or the like can be used as each of the circuit 75 and the circuit 76, for example.

Note that the reflective liquid crystal display device 20 may be divided into a plurality of regions horizontally and vertically, and pixels may be driven on a divided region basis.

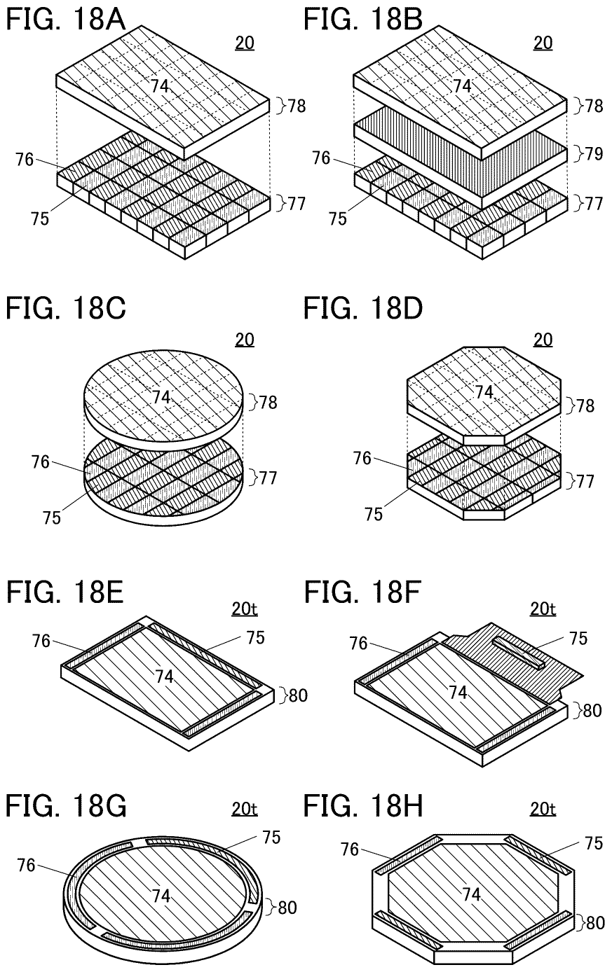

For example, as illustrated in FIG. 18A, each of the circuit 75 and the circuit 76 can be divided and arranged under the pixel array 74. In this case, the reflective liquid crystal display device 20 has a stacked-layer structure of a layer 77 and a layer 78, a plurality of circuits 75 and a plurality of circuits 76 are provided in the layer 77, and the pixel array 74 is provided in the layer 78 to overlap with the circuits 75 and the circuits 76.

Separate arrangement of each of the circuit 75 and the circuit 76 enables the pixel array 74 to be driven on a divided region basis. For example, the pixel array 74 can be operated at different frame rates from region to region. The pixel array 74 can be displayed with different definition from region to region, and can also be compatible with foveated rendering.

In addition, when the driver circuits are provided below the pixel array 74, wiring length can be shortened and wiring capacitance can be reduced. Accordingly, high-speed operation with low power consumption can be achieved. In addition, the reflective liquid crystal display device 20 can have a narrow bezel.

Note that the layouts and areas of the circuit 75 and the circuit 76 illustrated in FIG. 18A are examples and can be changed as appropriate. In addition, parts of the circuit 75 and the circuit 76 can be formed in the same layer as the pixel array 74. Furthermore, a circuit such as a memory circuit, an arithmetic circuit, or a communication circuit may be provided in the layer 77.

In this structure, for example, the layer 77 can be provided on a single crystal silicon substrate, the circuit 75 and the circuit 76 can be formed with transistors including silicon in channel formation regions (hereinafter Si transistors), and pixel circuits included in the pixel array 74 provided in the layer 78 can be formed with transistors including a metal oxide in channel formation regions (hereinafter OS transistors). An OS transistor can be formed using a thin film and can be formed to be stacked over a Si transistor.

Note that as illustrated in FIG. 18B, a structure where a layer 79 provided with an OS transistor is provided between the layer 77 and the layer 78 may be employed. An OS transistor constituting parts of the pixel circuits included in the pixel array 74 can be provided in the layer 79. Alternatively, an OS transistor constituting parts of the circuit 75 and the circuit 76 can be provided. Alternatively, an OS transistor constituting parts of the circuits that can be provided in the layer 77, such as a memory circuit, an arithmetic circuit, and a communication circuit, can be provided.

The top surface shape of the reflective liquid crystal display device 20 is not limited to a rectangle and may be a circle as illustrated in FIG. 18C. Alternatively, a polygon such as an octagon as illustrated in FIG. 18D may be employed.

In the transflective liquid crystal display device 20t, light that passes through a layer provided with the pixel array 74 is also utilized; thus, as illustrated in FIG. 18E, the pixel array 74, the circuit 75, and the circuit 76 are preferably provided over a layer 80. Note that a glass substrate, a quartz substrate, a resin substrate, or the like having a high visible light transmittance is preferably included in the layer 80 as a support substrate.

Although FIG. 18E illustrates an example in which the circuit 75 and the circuit 76 are monolithically provided, one or both of the circuit 75 and the circuit 76 may be provided to be mounted on an IC chip as illustrated in FIG. 18F.

The top surface shape of the transflective liquid crystal display device 20t is not limited to a rectangle and may be a circle as illustrated in FIG. 18G. Alternatively, a polygon such as an octagon as illustrated in FIG. 18H may be employed. Note that the reflective liquid crystal display device 20 can also be formed in the forms illustrated in FIG. 18E to FIG. 18H.

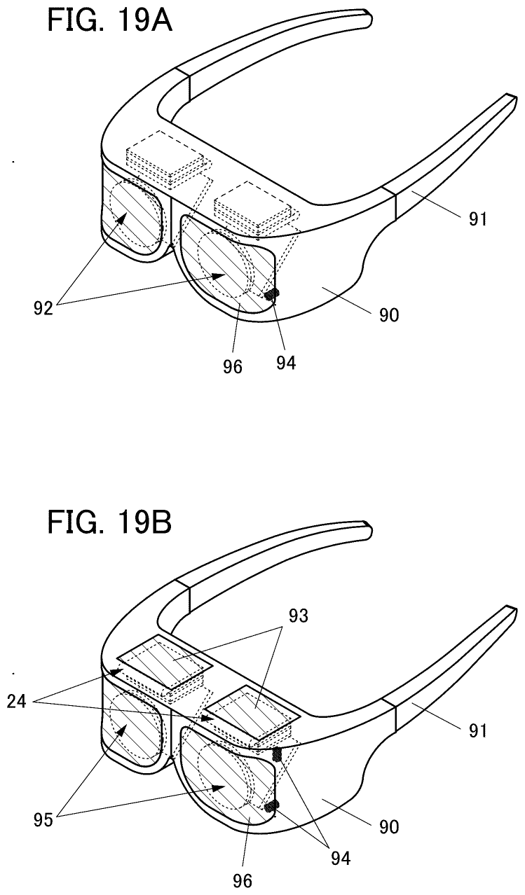

FIG. 19A is a diagram illustrating an example of a glasses-type device having the structure illustrated in FIG. 1. Here, a combination of the display device, the light source, and the optical device illustrated in FIG. 1 is shown by dashed lines as a display unit 92. The glasses-type device includes two pairs of the display units 92 stored in a housing 90.

A light-transmitting portion 96 is provided on the front surface of the housing 90, and external light is taken into the display unit 92 through the light-transmitting portion 96. Light of the display device included in the display unit 92 and external light are superimposed on each other, which enables visual perception by the user. The display device can display virtual information. The user can visually perceive the view and the display superimposed on each other, and thus can experience augmented reality where virtual information is superimposed on reality.

FIG. 19B is a diagram illustrating an example of a glasses-type device having the structure illustrated in FIG. 10, and is a diagram employing the structure in FIG. 14 where external light can be taken in from the side opposite to the light-emitting surface of the planar light source 24. Here, a combination of the display device, the light source, and the optical device each illustrated in FIG. 10 is shown by dashed lines as a display unit 95. The glasses-type device includes two pairs of the display units 95.

A lighting window 93 is provided on a top portion of the housing 90 to overlap with the planar light source 24. When external light is taken in through the lighting window 93, the external light can be utilized as a light source of the transflective liquid crystal display device, whereby the visibility of display at a high illuminance can be increased.

In addition, the housing 90 or a band 91 may be provided with an input terminal and an output terminal. To the input terminal, a cable for supplying a video signal from a video output device or the like, power for charging a battery provided in the housing 90, or the like can be connected. The output terminal can function as, for example, an audio output terminal to which earphones, headphones, or the like can be connected. Note that in the case where audio data can be output by wireless communication or sound is output from an external video output device, the audio output terminal is not necessarily provided.

In addition, a wireless communication module, a memory module, and the like may be provided inside the housing 90 or the band 91. Contents to be watched can be downloaded via wireless communication using the wireless communication module and can be stored in the memory module. In this manner, the user can watch the downloaded contents offline. Furthermore, information regarding a view that is visually perceived can be extracted via connection to the Internet.

In addition, a gaze sensor may be provided in the housing 90. For example, operation buttons for power-on, power-off, sleep, volume control, channel change, menu display, selection, confirmation, and back, and operation buttons for play, stop, pause, fast forward, and fast backward of moving images are displayed to be visually perceived, thereby enabling each of the operations to be performed.

In addition, an optical sensor 94 for sensing, detecting, or measuring the illuminance and chromaticity of external light is provided in the housing 90. As the optical sensor 94, a photodiode using a color filter in combination can be used, for example. In the structure illustrated in FIG. 19A, the optical sensor 94 can be provided in the vicinity of the light-transmitting portion 96. In the structure illustrated in FIG. 19B, the optical sensor 94 can be provided in two positions: in the vicinity of the light-transmitting portion 96 and in the vicinity of the lighting window 93.

As described above, in the electronic device of one embodiment of the present invention, when light emitted from a planar light source and external light are used as display light of a liquid crystal display device, the visibility of display at a high illuminance can be increased. Since the illuminance of external light is not constant, the intensity of light emitted from the planar light source is preferably adjusted to increase the visibility of display. Since the chromaticity of external light is not constant, the chromaticity of light emitted from the planar light source is preferably adjusted to make light incident on the liquid crystal display device be close to white light. When white light is incident on the liquid crystal display device, the chromaticity of display can be adjusted easily.

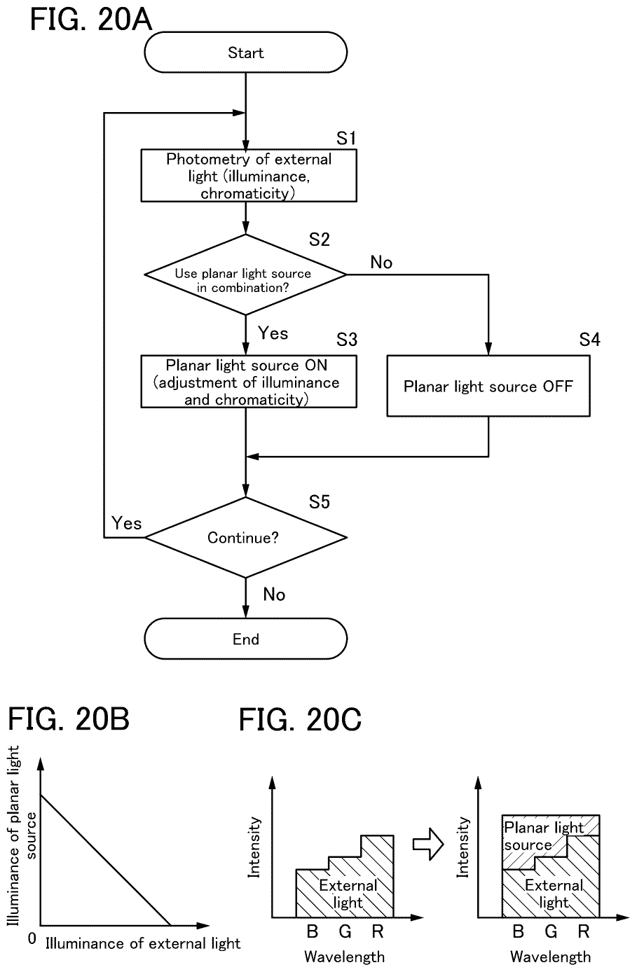

In other words, the emission intensity and chromaticity of the planar light source are preferably adjusted in accordance with the illuminance and chromaticity of external light. An example of a control operation of the planar light source is described with reference to a flow chart shown in FIG. 20A.

First, in Step 1 (S1), a photometry is performed on external light using the optical sensor 94 to measure the illuminance and chromaticity of external light. Next, in Step 2 (S2), whether or not to use the planar light source in combination is determined. To ensure a certain level of visibility of display on the liquid crystal display device, the illuminance of light incident on the liquid crystal display device from the light sources (the planar light source and external light) needs to be higher than a certain level.

Thus, with the use of a function where the illuminance of the planar light source has a negative slope with respect to external light illuminance as shown in FIG. 20B, the illuminance of the planar light source is preferably controlled such that the illuminance is decreased when external light illuminance is high and increased when external light illuminance is low. Such control can ensure a certain level of visibility of display while reducing the power consumption of the planar light source. Since the chromaticity of external light varies depending on the environment where the electronic device is used, the chromaticity is preferably adjusted by using the planar light source in combination regardless of external light illuminance.

Thus, in S2, based on the measurement results of the illuminance and chromaticity of external light, even when illuminance is sufficient, a determination is made to use the planar light source when chromaticity is biased. In that case, the operation proceeds to Step 3 (S3) and the planar light source is turned on.

For example, as illustrated on the left side in FIG. 20C, red light (R) sometimes has greater distribution than green light (G) and blue light (B) in the evening outdoors or the like. In such a case where the wavelength distribution is biased as described above, it can be said that external light deviates from white light.

In such a case, as illustrated on the right side in FIG. 20C, the wavelength distribution of light emitted from the planar light source is controlled such that light combined with external light becomes closer to white light or a color in the neighborhood thereof. For example, the color temperature is preferably controlled to be within the range of 3500 K to 6500 K. When the light incident on the liquid crystal display device is white light, the chromaticity of display can be easily adjusted. In order to perform such control, it is preferable that the planar light source include RGB light-emitting sources and the emission intensity of each color be controllable as illustrated in FIG. 2A and the like.

Note that when external light illuminance is sufficiently high and the chromaticity is substantially within the range of white color, the planar light source can be turned off in Step 4 (S4).

After S3 or S4, a determination is made on whether to continue to use the electronic device in Step 5 (S5); if the use is continued, the operation returns to S1, and if not, the operation ends.

With the use of one embodiment of the present invention for the glasses-type device, a small and thin electronic device with low power consumption and high reliability can be achieved.

At least part of this embodiment can be implemented in combination with the other embodiment and examples described in this specification as appropriate.

### Embodiment 2

In this embodiment, structure examples of a liquid crystal display device that can be employed for the electronic device of one embodiment of the present invention are described. The liquid crystal display device is a high-definition display panel, and is particularly suitably used for display portions of wearable devices that can be worn on a head, such as VR devices like head-mounted displays and glasses-type AR devices.

### [Display Module]

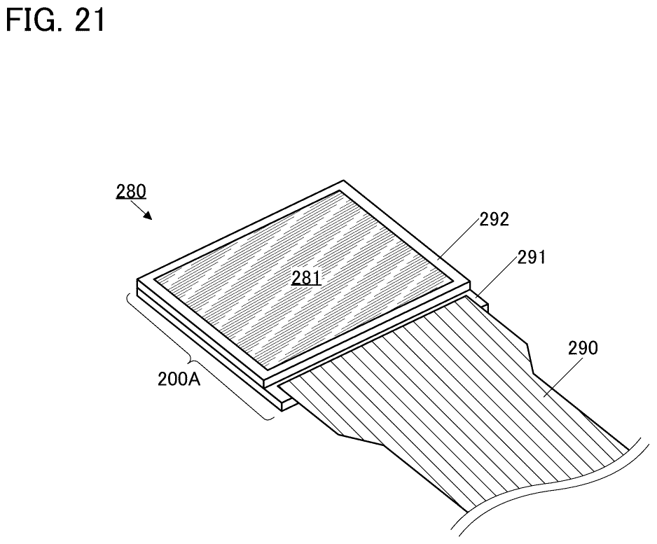

A perspective view of a display module 280 is shown in FIG. 21. The display module 280 includes a display panel 200A and an FPC 290. Note that a display panel included in the display module 280 is not limited to the display panel 200A and may be any of other display panels described later.

The display module 280 includes a substrate 291 and a substrate 292. The display module 280 includes a display portion 281. The display portion 281 is a region where an image is displayed and includes a liquid crystal element between the substrate 291 and the substrate 292.

### [Display Panel 200A]

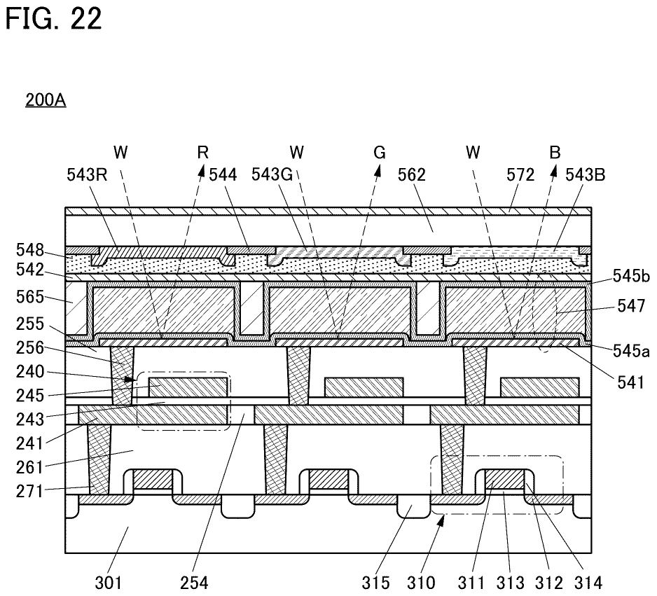

A cross-sectional view of the display panel 200A that can be used as the display module 280 is shown in FIG. 22. The display panel 200A includes a substrate 301, a liquid crystal element 547, a capacitor 240, and a transistor 310. The substrate 301 corresponds to the substrate 291 in FIG. 21. Note that the structure of a reflective liquid crystal display device is described here as an example.

The transistor 310 is a transistor including a channel formation region in the substrate 301. As the substrate 301, a semiconductor substrate such as a single crystal silicon substrate can be used, for example. The transistor 310 includes part of the substrate 301, a conductive layer 311, a low-resistance region 312, an insulating layer 313, and an insulating layer 314. The conductive layer 311 functions as a gate electrode. The insulating layer 313 is positioned between the substrate 301 and the conductive layer 311 and functions as a gate insulating layer. The low-resistance region 312 is a region where the substrate 301 is doped with an impurity, and functions as one of a source and a drain. The insulating layer 314 is provided to cover the side surface of the conductive layer 311.

In addition, an element isolation layer 315 is provided between two adjacent transistors 310 to be embedded in the substrate 301.

An insulating layer 261 is provided to cover the transistor 310, and the capacitor 240 is provided over the insulating layer 261.

The capacitor 240 includes a conductive layer 241, a conductive layer 245, and an insulating layer 243 positioned therebetween. The conductive layer 241 functions as one electrode of the capacitor 240, the conductive layer 245 functions as the other electrode of the capacitor 240, and the insulating layer 243 functions as a dielectric of the capacitor 240.

The conductive layer 241 is provided over the insulating layer 261 and is embedded in an insulating layer 254. The conductive layer 241 is electrically connected to one of the source and the drain of the transistor 310 through a plug 271 embedded in the insulating layer 261. The insulating layer 243 is provided to cover the conductive layer 241. The conductive layer 245 is provided in a region overlapping with the conductive layer 241 with the insulating layer 243 therebetween.

An insulating layer 255 is provided to cover the capacitor 240, and the liquid crystal element 547 is provided over the insulating layer 255. The liquid crystal element 547 has a structure in which a liquid crystal layer sandwiched between a pair of alignment films (alignment films 545a and 545b) is sandwiched between a pair of electrodes. The capacitor 240 and the transistor 310 are electrically connected to a pixel electrode 541 that is one electrode of the liquid crystal element through a plug 256. The pixel electrode 541 can be used as a reflective layer.

The pixel electrode 541 is preferably formed using a material having high reflectance of visible light. For example, a metal material such as aluminum, gold, platinum, silver, nickel, tungsten, chromium, molybdenum, iron, cobalt, copper, or palladium or an alloy containing any of these metal materials can be used. Lanthanum, neodymium, germanium, or the like may be added to the above-described metal material or the alloy of the above-described metal material. Alternatively, an alloy containing aluminum (an aluminum alloy) and titanium, nickel, or neodymium may be used. Alternatively, an alloy containing silver and copper, palladium, or magnesium may be used. An alloy containing silver and copper is preferable because of its high heat resistance. Furthermore, when a metal film or a metal oxide film is stacked in contact with an aluminum film or an aluminum alloy film, oxidation can be inhibited. Examples of materials for the metal film or the metal oxide film include titanium and titanium oxide. Alternatively, a conductive film transmitting visible light and a film formed of a metal material may be stacked. For example, a stacked-layer film of silver and indium tin oxide or a stacked-layer film of an alloy of silver and magnesium and indium tin oxide can be used.

A liquid crystal element using a variety of modes can be used as the liquid crystal element 547. For example, a liquid crystal element using a VA (Vertical Alignment) mode, a TN (Twisted Nematic) mode, an IPS (In-Plane-Switching) mode, an ASM (Axially Symmetric aligned Micro-cell) mode, an OCB (Optically Compensated Bend) mode, an FLC (Ferroelectric Liquid Crystal) mode, an AFLC (Antiferroelectric Liquid Crystal) mode, an ECB (Electrically Controlled Birefringence) mode, a VA-IPS mode, a guest-host mode, or the like can be used.

As the liquid crystal display device described in this embodiment, a normally black liquid crystal display device such as a transmissive liquid crystal display device that employs a vertical alignment (VA) mode may be used. As the vertical alignment mode, an MVA (Multi-Domain Vertical Alignment) mode, a PVA (Patterned Vertical Alignment) mode, an ASV (Advanced Super View) mode, and the like can be used.

Note that the liquid crystal element is a device that controls transmission and non-transmission of light by optical modulation action of the liquid crystal. The optical modulation action of the liquid crystal is controlled by an electric field applied to the liquid crystal (including a horizontal electric field, a vertical electric field, or an oblique electric field). As the liquid crystal used for the liquid crystal element, a thermotropic liquid crystal, a low-molecular liquid crystal, a high-molecular liquid crystal, a polymer dispersed liquid crystal (PDLC), a polymer network liquid crystal (PNLC), a ferroelectric liquid crystal, an anti-ferroelectric liquid crystal, or the like can be used. Such a liquid crystal material exhibits a cholesteric phase, a smectic phase, a cubic phase, a chiral nematic phase, an isotropic phase, or the like depending on conditions.

In addition, a spacer 565 is a columnar spacer that is obtained by selective etching of an insulating layer and is provided to control distance (a cell gap) between the pixel electrode 541 and a counter electrode 542. Note that a spherical spacer may be used.

The counter electrode 542 is preferably formed using a material having high transmittance of visible light. For example, indium oxide, indium tin oxide, indium zinc oxide, zinc oxide, or zinc oxide to which gallium is added can be used. Alternatively, a metal material such as gold, silver, platinum, magnesium, nickel, tungsten, chromium, molybdenum, iron, cobalt, copper, palladium, or titanium; an alloy containing any of these metal materials; or a nitride of any of these metal materials (e.g., titanium nitride) formed thin enough to have a light-transmitting property can be used. A stacked-layer film of any of the above materials can be used for a conductive layer. For example, a stacked-layer film of an alloy of silver and magnesium and indium tin oxide is preferably used, in which case conductivity can be increased. Further alternatively, graphene or the like may be used.

The liquid crystal display device includes a light-blocking layer 544, a coloring layer 543 (coloring layers 543R, 543G, and 543B), and an insulating layer 548 between a substrate 562 (corresponding to the substrate 292 in FIG. 21) and the counter electrode 542. Furthermore, a polarizing plate 572 is provided on a surface of the substrate 562.

Examples of a material that can be used for the light-blocking layer 544 include carbon black, titanium black, a metal, a metal oxide, and a composite oxide containing a solid solution of a plurality of metal oxides. The light-blocking layer 544 may be a film containing a resin material or may be a thin film of an inorganic material such as a metal. Stacked films containing the material of the coloring layer 543 can be also used for the light-blocking layer 544. For example, a stacked-layer structure of a film containing a material used for the coloring layer 543 that transmits light of a certain color and a film containing a material used for the coloring layer 543 that transmits light of another color can be used. Material sharing between the coloring layer 543 and the light-blocking layer is preferable because process simplification as well as equipment sharing can be achieved.

Examples of a material that can be used for the coloring layer 543 include a metal material, a resin material, and a resin material containing a pigment or a dye. By using the material that is selected as appropriate, light of R (red), G (green), B (blue), or the like can be generated, so that full-color display can be performed. The coloring layer 543R illustrated in FIG. 22 can transmit red light, the coloring layer 543G can transmit green light, and the coloring layer 543B can transmit blue light.

Note that a color conversion layer containing a semiconductor material may be used as a substitute for the coloring layer 543. For example, light with a certain wavelength that is incident on a layer containing a nano-sized semiconductor can be converted into light with another wavelength.

A certain kind of semiconductor enters an excited state when irradiated with light having high energy, and emits light when transferring to a stable state. At this time, the wavelength of light emitted from the semiconductor is determined by the energy gap of a semiconductor material. In a nano-sized semiconductor, an electron, a hole, or an exciton is confined to the inside of the semiconductor, which results in discrete energy states and an energy shift. Therefore, the wavelength of light emitted from the semiconductor is also changed.

Such a nano-sized semiconductor is referred to as a quantum dot. Since the amount of energy shift depends on the size of a quantum dot, an emission wavelength can be adjusted with ease by adjusting the size of the quantum dot. In addition, the discreteness of the quantum dot restricts phase relaxation, so that the width of the emission spectrum is narrow; thus, light emission with high color purity can be obtained. Accordingly, a color conversion layer containing a quantum dot can be used as a substitute for the coloring layer 543.

### [Display Panel 200D]

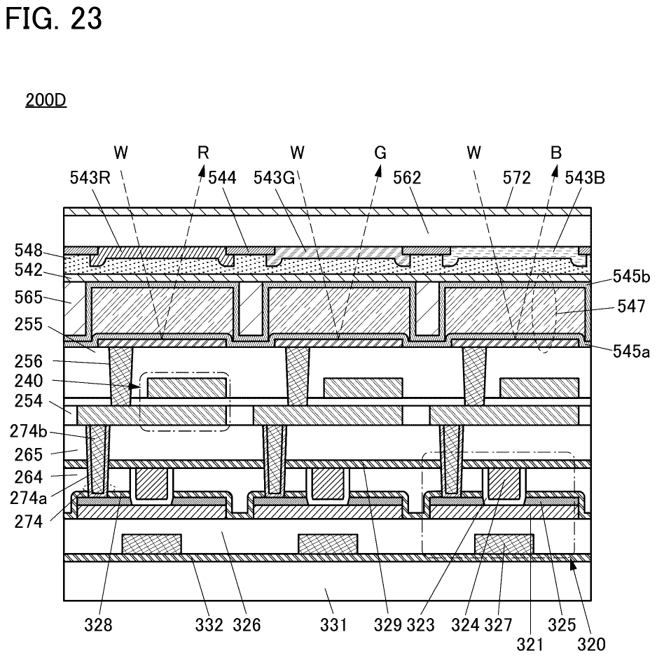

A display panel 200D illustrated in FIG. 23 differs from the display panel 200A mainly in a transistor structure.

A transistor 320 is a transistor (an OS transistor) in which a metal oxide (also referred to as an oxide semiconductor) is used for a semiconductor layer where a channel is formed.

The transistor 320 includes a semiconductor layer 321, an insulating layer 323, a conductive layer 324, a pair of conductive layers 325, an insulating layer 326, and a conductive layer 327.

A substrate 331 corresponds to the substrate 291 in FIG. 21. An insulating layer 332 is provided over the substrate 331. The insulating layer 332 functions as a barrier layer that prevents diffusion of impurities such as water or hydrogen from the substrate 331 into the transistor 320 and release of oxygen from the semiconductor layer 321 to the insulating layer 332 side. For the insulating layer 332, for example, a film that is less likely to diffuse hydrogen or oxygen than a silicon oxide film, such as an aluminum oxide film, a hafnium oxide film, or a silicon nitride film, can be used.

The conductive layer 327 is provided over the insulating layer 332, and the insulating layer 326 is provided to cover the conductive layer 327. The conductive layer 327 functions as a first gate electrode of the transistor 320, and part of the insulating layer 326 functions as a first gate insulating layer. An oxide insulating film such as a silicon oxide film is preferably used for at least part of the insulating layer 326 that is in contact with the semiconductor layer 321. The top surface of the insulating layer 326 is preferably planarized.

The semiconductor layer 321 is provided over the insulating layer 326. The semiconductor layer 321 preferably includes a metal oxide (also referred to as an oxide semiconductor) film exhibiting semiconductor characteristics. The pair of conductive layers 325 is provided over and in contact with the semiconductor layer 321, and functions as a source electrode and a drain electrode.

An insulating layer 328 is provided to cover the top and side surfaces of the pair of conductive layers 325, the side surface of the semiconductor layer 321, and the like, and an insulating layer 264 is provided over the insulating layer 328. The insulating layer 328 functions as a barrier layer that prevents diffusion of impurities such as water or hydrogen from the insulating layer 264 or the like into the semiconductor layer 321 and release of oxygen from the semiconductor layer 321. For the insulating layer 328, an insulating film similar to the insulating layer 332 can be used.

An opening reaching the semiconductor layer 321 is provided in the insulating layer 328 and the insulating layer 264. The conductive layer 324 and the insulating layer 323 that is in contact with the top surface of the semiconductor layer 321 are embedded in the opening. The conductive layer 324 functions as a second gate electrode, and the insulating layer 323 functions as a second gate insulating layer.

The top surface of the conductive layer 324, the top surface of the insulating layer 323, and the top surface of the insulating layer 264 are subjected to planarization treatment to be level with or substantially level with each other, and an insulating layer 329 and an insulating layer 265 are provided to cover these layers.

The insulating layer 264 and the insulating layer 265 each function as an interlayer insulating layer. The insulating layer 329 functions as a barrier layer that prevents diffusion of impurities such as water or hydrogen from the insulating layer 265 or the like into the transistor 320. For the insulating layer 329, an insulating film similar to the insulating layer 328 and the insulating layer 332 can be used.

A plug 274 electrically connected to one of the pair of conductive layers 325 is provided to be embedded in the insulating layer 265, the insulating layer 329, and the insulating layer 264. Here, the plug 274 preferably includes a conductive layer 274a that covers the side surfaces of openings in the insulating layer 265, the insulating layer 329, the insulating layer 264, and the insulating layer 328 and part of the top surface of the conductive layer 325, and a conductive layer 274b in contact with the top surface of the conductive layer 274a. In that case, a conductive material that is less likely to diffuse hydrogen and oxygen is preferably used for the conductive layer 274a.

Note that there is no particular limitation on the structures of the transistors included in the display panels of this embodiment. For example, a planar transistor, a staggered transistor, an inverted staggered transistor, or the like can be used. A top-gate transistor structure or a bottom-gate transistor structure may be employed. Gates may be provided above and below a semiconductor layer where a channel is formed.

A structure in which the semiconductor layer where a channel is formed is interposed between two gates is employed for the transistor 320. The two gates may be connected to each other and supplied with the same signal to drive the transistor. Alternatively, a potential for controlling the threshold voltage may be supplied to one of the two gates and a potential for driving may be supplied to the other of the two gates to control the threshold voltage of the transistor.

There is no particular limitation on the crystallinity of a semiconductor material used for the semiconductor layer of the transistor, and any of an amorphous semiconductor, a single crystal semiconductor, and a semiconductor having crystallinity other than single crystal (a microcrystalline semiconductor, a polycrystalline semiconductor, or a semiconductor partly including crystal regions) may be used. A single crystal semiconductor or a semiconductor having crystallinity is preferably used, in which case deterioration of the transistor characteristics can be inhibited.

The bandgap of a metal oxide used for the semiconductor layer of the transistor is preferably greater than or equal to 2 eV, further preferably greater than or equal to 2.5 eV. The use of a metal oxide having a wide bandgap can reduce the off-state current of the OS transistor.

A metal oxide preferably contains at least indium or zinc, and further preferably contains indium and zinc. A metal oxide preferably contains indium, M (M is one or more kinds selected from gallium, aluminum, yttrium, tin, silicon, boron, copper, vanadium, beryllium, titanium, iron, nickel, germanium, zirconium, molybdenum, lanthanum, cerium, neodymium, hafnium, tantalum, tungsten, magnesium, and cobalt), and zinc, for example.

Alternatively, the semiconductor layer of the transistor may contain silicon. Examples of silicon include amorphous silicon and crystalline silicon (low-temperature polysilicon, single crystal silicon, or the like).

Examples of the metal oxide that can be used for the semiconductor layer include indium oxide, gallium oxide, and zinc oxide. In addition, the metal oxide preferably contains two or three kinds selected from indium, the element M, and zinc. Note that the element M is one or more kinds selected from gallium, aluminum, silicon, boron, yttrium, tin, copper, vanadium, beryllium, titanium, iron, nickel, germanium, zirconium, molybdenum, lanthanum, cerium, neodymium, hafnium, tantalum, tungsten, and magnesium. Specifically, the element M is preferably one or more kinds selected from aluminum, gallium, yttrium, and tin.

Note that in the case where a metal oxide is used for the semiconductor layer, the metal oxide is preferably formed by a sputtering method or an ALD method. In the case where the metal oxide is formed by a sputtering method, the productivity can be increased and the film density can also be increased. In the case where the metal oxide is formed by an ALD method, coverage with a film can be improved.

It is particularly preferable that an oxide containing indium, gallium, and zinc (also referred to as IGZO) be used as the metal oxide used for the semiconductor layer. Alternatively, it is preferable to use an oxide containing indium, tin, and zinc (also referred to as ITZO (registered trademark)). Alternatively, it is preferable to use an oxide containing indium, gallium, tin, and zinc. Alternatively, it is preferable to use an oxide containing indium, aluminum, and zinc (also referred to as IAZO). Alternatively, it is preferable to use an oxide containing indium, aluminum, gallium, and zinc (also referred to as IAGZO). Alternatively, it is preferable to use an oxide containing indium and zinc. Alternatively, it is preferable to use an oxide containing indium and gallium.

When the metal oxide used for the semiconductor layer is In-M-Zn oxide, the atomic ratio of In is preferably higher than or equal to the atomic ratio of M in the In-M-Zn oxide. Examples of the atomic ratio of the metal elements in such In-M-Zn oxide include In: M: Zn=1:1:1 or a composition in the neighborhood thereof, In: M: Zn=1:1:1.2 or a composition in the neighborhood thereof, In: M: Zn=1:3:2 or a composition in the neighborhood thereof, In: M: Zn=1:3:4 or a composition in the neighborhood thereof, In: M: Zn=2:1:3 or a composition in the neighborhood thereof, In: M: Zn=3:1:2 or a composition in the neighborhood thereof, In: M: Zn=4:2:3 or a composition in the neighborhood thereof, In: M: Zn=4:2:4.1 or a composition in the neighborhood thereof, In: M: Zn=5:1:3 or a composition in the neighborhood thereof, In: M: Zn=5:1:6 or a composition in the neighborhood thereof, In: M: Zn=5:1:7 or a composition in the neighborhood thereof, In: M: Zn=5:1:8 or a composition in the neighborhood thereof, In: M: Zn=6:1:6 or a composition in the neighborhood thereof, and In: M: Zn=5:2:5 or a composition in the neighborhood thereof. Note that a composition in the neighborhood includes the range of ±30% of an intended atomic ratio.

In addition, it is particularly preferable to use gallium or tin as the element M. Note that a plurality of the above elements may be used in combination as the element M. A metal oxide with In: M: Zn=40:1:10 or the neighborhood thereof is preferably used for the semiconductor layer. Specifically, a metal oxide with In: Sn: Zn=40:1:10 or the neighborhood thereof can be suitably used.

For example, when the atomic ratio is described as In: Ga: Zn=4:2:3 or a composition in the neighborhood thereof, the case is included where Ga is greater than or equal to 1 and less than or equal to 3 and Zn is greater than or equal to 2 and less than or equal to 4 with In being 4. In addition, when the atomic ratio is described as In: Ga: Zn=5:1:6 or a composition in the neighborhood thereof, the case is included where Ga is greater than 0.1 and less than or equal to 2 and Zn is greater than or equal to 5 and less than or equal to 7 with In being 5. Furthermore, when the atomic ratio is described as In: Ga: Zn=1:1:1 or a composition in the neighborhood thereof, the case is included where Ga is greater than 0.1 and less than or equal to 2 and Zn is greater than 0.1 and less than or equal to 2 with In being 1.

The semiconductor layer may include two or more metal oxide layers having different compositions. For example, a stacked-layer structure of a first metal oxide layer having In: M: Zn=1:3:4 [atomic ratio] or a composition in the neighborhood thereof and a second metal oxide layer having In: M: Zn=1:1:1 [atomic ratio] or a composition in the neighborhood thereof and being formed over the first metal oxide layer can be favorably employed. In particular, gallium or aluminum is preferably used as the element M.

Alternatively, a stacked-layer structure or the like of one selected from indium oxide, indium gallium oxide, and IGZO, and one selected from IAZO, IAGZO, and ITZO (registered trademark) may be used, for example.

As an oxide semiconductor having crystallinity, for example, an oxide semiconductor having a CAAC (c-axis aligned crystal) structure, a polycrystalline (poly-crystal) structure, a nano-crystal (nc) structure, or the like can be used. An oxide semiconductor having crystallinity has a low density of defect states, so that a highly reliable transistor can be achieved. Note that the CAAC structure is a crystal structure in which a plurality of microcrystals (typically, a plurality of IGZO microcrystals) have c-axis alignment and the above plurality of microcrystals are connected in an a-b plane without alignment. In the CAAC structure, crystal grain boundaries are observed in the a-b plane less clearly than in a polycrystalline structure; thus, a highly reliable transistor can be achieved.

An OS transistor has much higher field-effect mobility than a transistor containing amorphous silicon. In addition, the OS transistor has an extremely low leakage current between a source and a drain in an off state (hereinafter also referred to as an off-state current), and charge accumulated in a capacitor that is connected in series to the transistor can be held for a long period. Furthermore, the power consumption of the display panel can be reduced with the use of the OS transistor.

[Display Panel 200f]

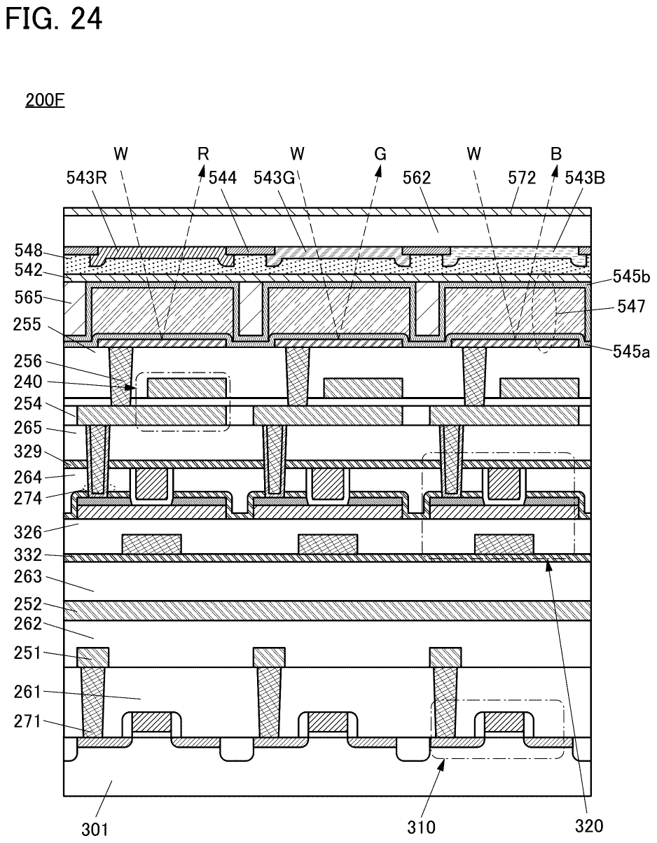

A display panel 200F illustrated in FIG. 24 has a stacked-layer of the transistor 310 whose channel is formed in the substrate 301 and the transistor 320 including a metal oxide in the semiconductor layer where the channel is formed.

The insulating layer 261 is provided to cover the transistor 310, and a conductive layer 251 is provided over the insulating layer 261. In addition, an insulating layer 262 is provided to cover the conductive layer 251, and a conductive layer 252 is provided over the insulating layer 262. The conductive layer 251 and the conductive layer 252 each function as a wiring. Furthermore, an insulating layer 263 and the insulating layer 332 are provided to cover the conductive layer 252, and the transistor 320 is provided over the insulating layer 332. Moreover, the insulating layer 265 is provided to cover the transistor 320, and the capacitor 240 is provided over the insulating layer 265. The capacitor 240 and the transistor 320 are electrically connected to each other through the plug 274.

The transistor 320 can be used as a transistor included in the pixel circuit. In addition, the transistor 310 can be used as a transistor included in the pixel circuit or a transistor included in a driver circuit (a gate line driver circuit or a source line driver circuit) for driving the pixel circuit. Furthermore, the transistor 310 and the transistor 320 can be used as transistors included in a variety of circuits such as an arithmetic circuit or a memory circuit.

With such a structure, not only the pixel circuit but also the driver circuit and the like can be formed directly under the light-emitting devices; thus, the display panel can be downsized as compared with the case where the driver circuit is provided around a display region.

[Display Panel 200g]

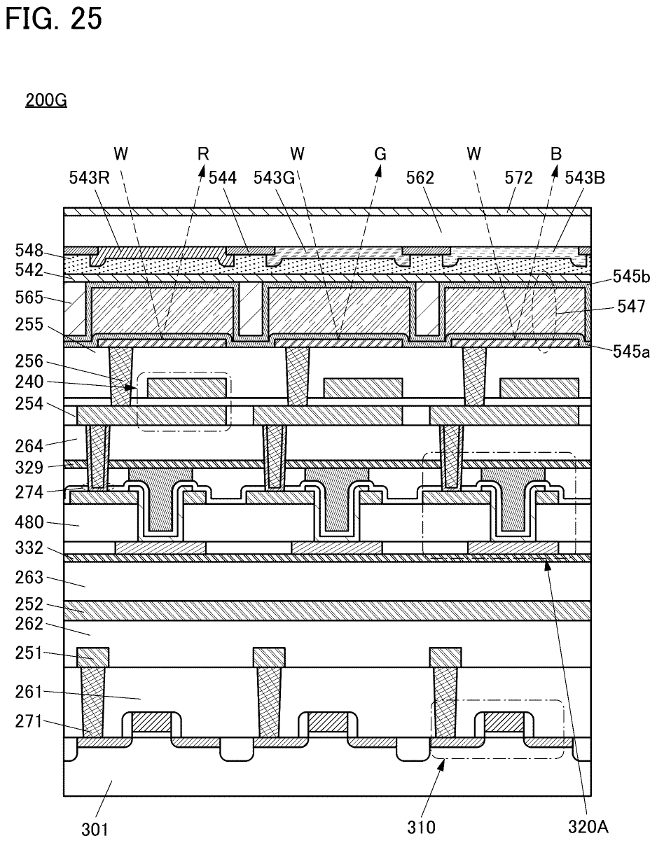

A display panel 200G illustrated in FIG. 25 has a structure in which the transistor 320 in the display panel 200F illustrated in FIG. 24 is replaced with a transistor 320A (vertical transistor). Note that the structure in which the transistor 320 is replaced with the transistor 320A can also be employed for the display panel 200D illustrated in FIG. 23.

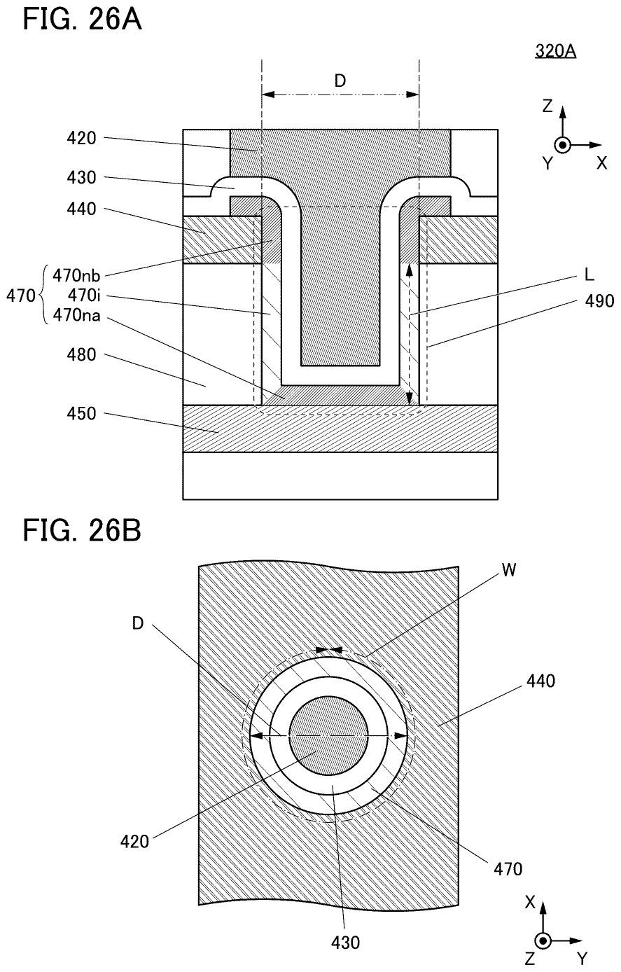

FIG. 26A is a cross-sectional view of the transistor 320A taken along the XZ plane. FIG. 26B is a cross-sectional view taken along the XY plane including a wiring 440.

The transistor 320A includes an oxide semiconductor 470, an insulator 430, and a conductor 420. The oxide semiconductor 470 functions as a semiconductor layer, the insulator 430 functions as a gate insulator, and the conductor 420 functions as a gate electrode. A wiring 450 includes a region functioning as one of the source electrode and the drain electrode of the transistor 320A. The wiring 440 includes a region functioning as the other of the source electrode and the drain electrode of the transistor 320A.

In the wiring 440 and an insulator 480, an opening portion 490 penetrating therethrough and reaching the wiring 450 is provided. The opening portion 490 has a columnar shape with a substantially circular top surface. With such a structure, the memory cell can be miniaturized or highly integrated. Note that the side surface of the opening portion 490 is preferably perpendicular to the top surface of the wiring 450.

At least part of the oxide semiconductor 470 is placed in the opening portion 490. Note that the oxide semiconductor 470 includes a region in contact with the top surface of the wiring 450, a region in contact with the side surface of the wiring 440, and a region in contact with the side surface of the insulator 480 in the opening portion 490.

The insulator 430 is placed to at least partly cover the opening portion 490. The conductor 420 is placed to be at least partly positioned in the opening portion 490. The conductor 420 is preferably provided to fill the opening portion 490, and preferably has a substantially circular top surface for a higher integration degree.

As illustrated in FIG. 26A, the oxide semiconductor 470 includes a region 470i, and a region 470na and a region 470nb provided such that the region 470i is sandwiched therebetween.

The region 470na is a region in contact with the wiring 450 in the oxide semiconductor 470. At least part of the region 470na functions as one of the source region and the drain region of the transistor 320A. The region 470nb is a region in contact with the wiring 440 in the oxide semiconductor 470. At least part of the region 470nb functions as the other of the source region and the drain region of the transistor 320A. As illustrated in FIG. 26B, the wiring 440 is in contact with the entire outer circumference of the oxide semiconductor 470. Thus, the other of the source region and the drain region of the transistor 320A can be formed in the entire outer circumference of a portion of the oxide semiconductor 470 that is formed in the same layer as the wiring 440.

The region 470i is a region sandwiched between the region 470na and the region 470nb in the oxide semiconductor 470. At least part of the region 470i functions as a channel formation region of the transistor 320A. That is, the channel formation region of the transistor 320A is formed in part of the oxide semiconductor 470 that is positioned in a region between the wiring 450 and the wiring 440. In other words, it can be said that the channel formation region of the transistor 320A is positioned in a region of the oxide semiconductor 470 that is in contact with the insulator 480 or a region in the vicinity thereof.

The channel length of the transistor 320A is the distance between the source region and the drain region. That is, the channel length of the transistor 320A is determined by the thickness of the insulator 480 over the wiring 450. In FIG. 26A, a channel length L of the transistor 320A is indicated by a dashed double-headed arrow. In the cross-sectional view, the channel length L is a distance between an end portion of a region where the oxide semiconductor 470 is in contact with the wiring 450 and an end portion of a region where the oxide semiconductor 470 is in contact with the wiring 440. That is, the channel length L corresponds to the length of the side surface of the insulator 480 on the opening portion 490 side in the cross-sectional view.

In a conventional transistor, the channel length is determined by the light exposure limit of photolithography; however, in one embodiment of the present invention, the channel length can be determined by the thickness of the insulator 480. Thus, the transistor 320A can have an extremely small channel length less than or equal to the light exposure limit of photolithography (e.g., less than or equal to 60 nm, less than or equal to 50 nm, less than or equal to 40 nm, less than or equal to 30 nm, less than or equal to 20 nm, or less than or equal to 10 nm, and greater than or equal to 1 nm or greater than or equal to 5 nm). In that case, the transistor 320A can have a higher on-state current.

In addition, as described above, the channel formation region, the source region, and the drain region can be formed in the opening portion 490. Thus, the occupation area of the transistor 320A can be reduced as compared with a conventional transistor in which a channel formation region, a source region, and a drain region are provided separately on the XY plane. Accordingly, the pixel density can be increased.

Such a transistor including the channel formation region along the side surface of the insulator 480 in the opening portion 490 is also referred to as a vertical transistor.

Also in the XY plane including the channel formation region of the oxide semiconductor 470, the oxide semiconductor 470, the insulator 430, and the conductor 420 are provided concentrically as in FIG. 26B. Thus, the side surface of the conductor 420 provided at the center faces the side surface of the oxide semiconductor 470 with the insulator 430 therebetween. That is, in the top view, the entire circumference of the oxide semiconductor 470 serves as the channel formation region. In this case, for example, the channel width of the transistor 320A is determined by the length of the outer circumference of the oxide semiconductor 470. In other words, it can be said that the channel width of the transistor 320A is determined by the maximum width of the opening portion 490 (the maximum diameter in the case where the opening portion 490 is circular in the top view). In FIG. 26A and FIG. 26B, a maximum width D of the opening portion 490 is indicated by a dashed double-dotted double-headed arrow. In FIG. 26B, a channel width W of the transistor 320A is indicated by a dashed-dotted double-headed arrow. By increasing the maximum width D of the opening portion 490, the channel width per unit area can be increased and the on-state current can be increased.

In the case where the opening portion 490 is formed by a photolithography method, the maximum width D of the opening portion 490 is determined by the light exposure limit of photolithography. In addition, the maximum width D of the opening portion 490 is determined by the thicknesses of the oxide semiconductor 470, the insulator 430, and the conductor 420 provided in the opening portion 490. The maximum width D of the opening portion 490 is preferably, for example, greater than or equal to 5 nm, greater than or equal to 10 nm, or greater than or equal to 20 nm and less than or equal to 100 nm, less than or equal to 60 nm, less than or equal to 50 nm, less than or equal to 40 nm, or less than or equal to 30 nm. In the case where the opening portion 490 is circular in the top view, the maximum width D of the opening portion 490 corresponds to the diameter of the opening portion 490, and the channel width W can be calculated to be “D×π”.

In the storage device of one embodiment of the present invention, the channel length L of the transistor 320A is preferably smaller than at least the channel width W of the transistor 320A. The channel length L of the transistor 320A in one embodiment of the present invention is greater than or equal to 0.1 times and less than or equal to 0.99 times, preferably greater than or equal to 0.5 times and less than or equal to 0.8 times the channel width W of the transistor 320A. This structure enables a transistor with favorable electrical characteristics and high reliability.

In the case where the opening portion 490 is formed to be substantially circular in the top view, the oxide semiconductor 470, the insulator 430, and the conductor 420 are provided concentrically. This allows for a substantially uniform distance between the conductor 420 and the oxide semiconductor 470, enabling substantially uniform application of a gate electric field to the oxide semiconductor 470.

It is preferable that the channel formation region of the transistor including an oxide semiconductor in the semiconductor layer include fewer oxygen vacancies or have a lower concentration of impurities such as hydrogen, nitrogen, or a metal element than the source region and the drain region. For example, the concentration of aluminum in the channel formation region of the oxide semiconductor is preferably lower than or equal to 1×10²² atoms/cm³, further preferably lower than or equal to 1×10²¹ atoms/cm³, still further preferably lower than or equal to 1×10²⁰ atoms/cm³, yet further preferably lower than or equal to 5×10¹⁹ atoms/cm³, yet still further preferably lower than or equal to 1×10¹⁹ atoms/cm³, yet still further preferably lower than or equal to 5×10¹⁸ atoms/cm³, yet still further preferably lower than or equal to 1×10¹⁸ atoms/cm³.

In some cases, hydrogen in the vicinity of an oxygen vacancy forms a defect that is an oxygen vacancy hydrogen has entered (hereinafter sometimes referred to as VoH), which generates an electron serving as a carrier. Thus, it is preferable that VoH be also decreased in the channel formation region. Thus, the channel formation region of the transistor is a high-resistance region having a low carrier concentration. Thus, the channel formation region of the transistor can be regarded as being i-type (intrinsic) or substantially i-type.

The source region and the drain region of the transistor including an oxide semiconductor in the semiconductor layer include more oxygen vacancies or VoH or have a higher concentration of impurities such as hydrogen, nitrogen, or a metal element than the channel formation region, thereby having a higher carrier concentration and lower resistance. That is, the source region and the drain region of the transistor are n-type regions that have a higher carrier concentration and lower resistance than the channel formation region.

Although the opening portion 490 is provided such that the side surface of the opening portion 490 is perpendicular to the top surface of the wiring 450 in FIG. 26A and the like, the present invention is not limited thereto. For example, the side surface of the opening portion 490 may have a tapered shape.

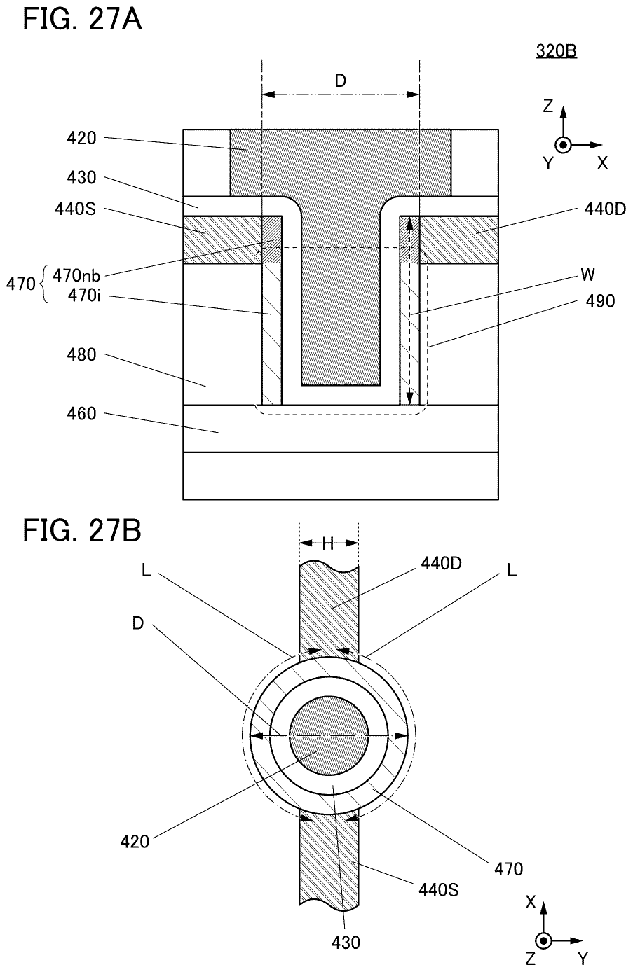

FIG. 27A illustrates a cross-sectional view taken along an XZ plane of a transistor 320B that is a vertical transistor with a structure different from that in FIG. 26. FIG. 27B is a cross-sectional view taken along an XY plane.

The transistor 320B is different from the transistor 320A mainly in not including the wiring 450, being provided over an insulator 460, including a wiring 440S and a wiring 440D instead of the wiring 440, and having a different shape of the oxide semiconductor 470. The wiring 440S has a function of a source electrode, and the wiring 440D has a function of a drain electrode.

The oxide semiconductor 470 has a ring shape. Specifically, the oxide semiconductor 470 includes a region in contact with the side surface of the wiring 440S, a region in contact with the side surface of the wiring 440D, and a region in contact with the side surface of the insulator 480 in the opening portion 490. Here, the oxide semiconductor 470 is in contact with neither of the top surfaces of the wiring 440S and the wiring 440D. The oxide semiconductor 470 having such a shape can be formed by processing by anisotropic etching, for example.

As illustrated in FIG. 27B, a width H of each of the wiring 440S and the wiring 440D is smaller than the maximum width D of the opening portion 490. In that case, the circumferential direction of the opening portion 490 corresponds to the channel length direction of the transistor 320B. Here, since the oxide semiconductor 470 has a ring shape, there are two kinds of current paths (i.e., channels) from the wiring 440S to the wiring 440D. Note that the oxide semiconductor 470 does not necessarily have a circular shape and may be in contact with both the wiring 440S and the wiring 440D.

The channel length can be controlled by the shape and size of the opening portion 490. For example, in the case where the channel length is desired to be large, the perimeter of the opening portion 490 is set long. Although an example where the opening portion 490 is circular in the plan view is described, the present invention is not limited thereto. For example, the opening portion 490 can have an elliptical shape or a quadrangular shape with rounded corners besides the circular shape in the plan view. Alternatively, a regular polygonal shape such as an equilateral triangle shape, a square shape, or an equilateral pentagon shape, or a polygonal shape other than the regular polygonal shape may be employed. By employing a concave polygonal shape in which at least one interior angle is greater than 180°, such as a star polygonal shape, the channel width can be increased. Alternatively, an elliptical shape, a polygonal shape with rounded corners, a closed curve in which a straight line and a curve are combined, or the like can be employed. In that case, the maximum width of the opening portion 490 is calculated as appropriate in accordance with the shape of the uppermost portion of the opening portion 490. For example, in the case where the opening portion is square or rectangular in the plan view, the maximum width of the opening portion 490 is preferably the length of a diagonal line of the uppermost portion of the opening portion 490.

In addition, as illustrated in FIG. 27A, the height of the oxide semiconductor 470 corresponds to the channel width W of the transistor 320B. Thus, the channel width W of the transistor 320B can be controlled by the thickness of the insulator 480. Thus, the transistor 320B can have an extremely small channel width less than or equal to the light exposure limit of photolithography (e.g., less than or equal to 60 nm, less than or equal to 50 nm, less than or equal to 40 nm, less than or equal to 30 nm, less than or equal to 20 nm, or less than or equal to 10 nm, and greater than or equal to 1 nm or greater than or equal to 5 nm).

The transistor 320A can have an extremely small channel length and a large channel width, and thus can achieve a high on-state current. Meanwhile, the transistor 320B can have an extremely small channel width and a large channel length, and thus can achieve an appropriate on-state current and easy design. The transistor 320A and the transistor 320B can share some of the fabrication steps and be separately formed over the same substrate.

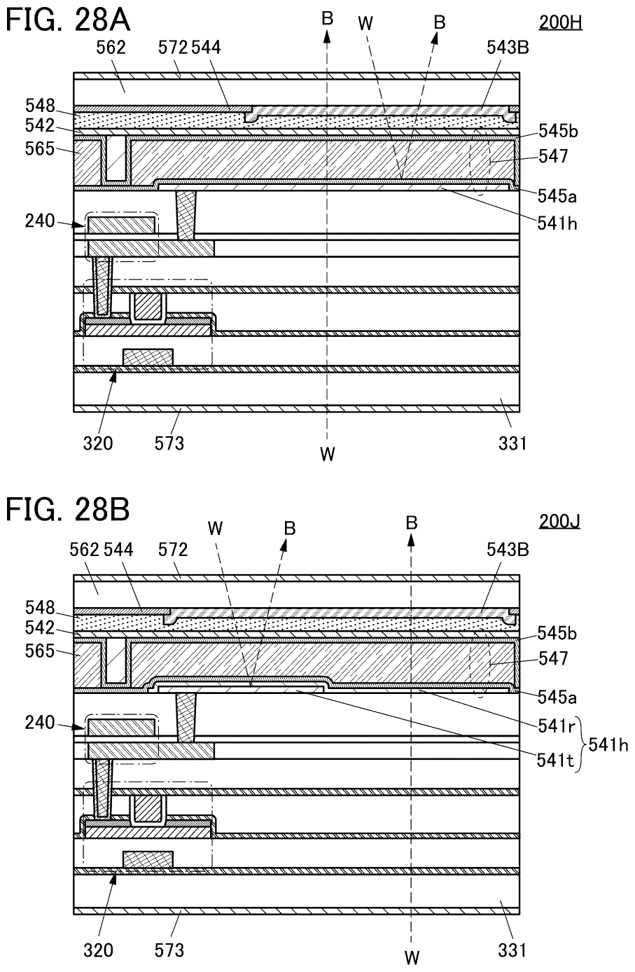

FIG. 28A and FIG. 28B are diagrams illustrating examples of a transflective liquid crystal display device. The transflective liquid crystal display device uses light that passes through a substrate as display light; thus, a substrate opaque to visible light such as a silicon substrate cannot be used. Thus, a structure similar to that of the display panel 200D illustrated in FIG. 16 can be used for a circuit portion.

[Display Panel 200h]

A display panel 200H illustrated in FIG. 28A has a structure in which a half mirror type transflective layer is used for a pixel electrode 541h and corresponds to the transflective liquid crystal display device 20t illustrated in FIG. 11A. As the pixel electrode 541h, a thin metal layer that can transmit light can be used. Alternatively, a stack of a thin metal layer and a light-transmitting conductive film may be used. Furthermore, a polarizing plate 573 is provided on a surface of the substrate 331.

For the metal layer, for example, a metal material such as gold, silver, platinum, magnesium, nickel, tungsten, chromium, molybdenum, iron, cobalt, copper, palladium, or titanium; an alloy containing any of these metal materials; or a nitride of any of these metal materials (e.g., titanium nitride) can be used. For the light-transmitting conductive film, a material having high transmittance of visible light that can be used for the counter electrode 542 can be used.

A coloring layer (here, the coloring layer 543B is illustrated as an example) is provided over the liquid crystal element 547. White light (W) that passes through the pixel electrode 541h is absorbed by the coloring layer 543B except for blue light and can be emitted to the outside. Moreover, white light entering from the coloring layer 543B side is absorbed by the coloring layer 543B except for blue light, reflected by the pixel electrode 541h, and can be emitted to the outside. Thus, the operation of both a transmissive liquid crystal display device and a reflective liquid crystal display device can be performed.

### [Display Panel 200J]

A display panel 200J illustrated in FIG. 28B has a structure in which the pixel electrode 541h includes a conductive layer 541r that reflects light and a conductive layer 541t that transmits light, and corresponds to the transflective liquid crystal display device 20t illustrated in FIG. 11B. Part of the conductive layer 541t is provided over the conductive layer 541r, whereby the conductive layers are electrically connected to each other. The operation of a reflective liquid crystal display device can be performed in a region where the conductive layer 541r is provided, and the operation of a transmissive liquid crystal display device can be performed in a region where the conductive layer 541t is provided.

For the conductive layer 541r, a material having high transmittance of visible light that can be used for the counter electrode 542 can be used. For the conductive layer 541t, any of the above-described materials having high reflectance of visible light that can be used for the pixel electrode 541 can be used.

At least part of this embodiment can be implemented in combination with the other embodiment and examples described in this specification as appropriate.

### REFERENCE NUMERALS

10: eye, 20t: transflective liquid crystal display device, 20: reflective liquid crystal display device, 21: liquid crystal layer, 22: linear polarizing plate, 23h: transflective layer, 23t: light-transmitting layer, 23r: reflective layer, 23: reflective layer, 24B: light-emitting source, 24G: light-emitting source, 24L: light-emitting source, 24P: light guide plate, 24R: light-emitting source, 24T: trigger, 24: planar light source, 25: retardation plate, 26: linear polarizing plate, 27M: reflective layer, 27: planar light source, 28: linear polarizing plate, 30: reflective polarizing plate, 31: lens, 32: lens, 33: lens, 34: lens, 41: retardation plate, 42: half mirror, 70: pixel, 71: subpixel, 74: pixel array, 75: circuit, 76: circuit, 77: layer, 78: layer, 79: layer, 80: layer, 90: housing, 91: band, 92: display unit, 93: lighting window, 94: optical sensor, 95: display unit, 96: light-transmitting portion, 200A: display panel, 200D: display panel, 200F: display panel, 200G: display panel, 200H: display panel, 200J: display panel, 240: capacitor, 241: conductive layer, 243: insulating layer, 245: conductive layer, 251: conductive layer, 252: conductive layer, 254: insulating layer, 255: insulating layer, 256: plug, 261: insulating layer, 262: insulating layer, 263: insulating layer, 264: insulating layer, 265: insulating layer, 271: plug, 274a: conductive layer, 274b: conductive layer, 274: plug, 280: display module, 281: display portion, 290: FPC, 291: substrate, 292: substrate, 301: substrate, 310: transistor, 311: conductive layer, 312: low-resistance region, 313: insulating layer, 314: insulating layer, 315: element isolation layer, 320A: transistor, 320B: transistor, 320: transistor, 321: semiconductor layer, 323: insulating layer, 324: conductive layer, 325: conductive layer, 326: insulating layer, 327: conductive layer, 328: insulating layer, 329: insulating layer, 331: substrate, 332: insulating layer, 420: conductor, 430: insulator, 440D: wiring, 440S: wiring, 440: wiring, 450: wiring, 460: insulator, 470i: region, 470na: region, 470nb: region, 470: oxide semiconductor, 480: insulator, 490: opening portion, 541h: pixel electrode, 541r: conductive layer, 541t: conductive layer, 541: pixel electrode, 542: counter electrode, 543B: coloring layer, 543G: coloring layer, 543R: coloring layer, 543: coloring layer, 544: light-blocking layer, 545a: alignment film, 545b: alignment film, 547: liquid crystal element, 548: insulating layer, 562: substrate, 565: spacer, 572: polarizing plate, 573: polarizing plate

1. An electronic device comprising:
a reflective liquid crystal display device, a planar light source, a reflective polarizing plate, a first retardation plate, and a half mirror,
wherein a display surface of the reflective liquid crystal display device faces a light-emitting surface of the planar light source,
wherein the reflective polarizing plate is positioned at an angle at which light that is emitted from the display surface and travels straight through the planar light source is incident obliquely, and
wherein the reflective polarizing plate, the first retardation plate, and the half mirror are positioned in this order in a direction in which the light reflected by the reflective polarizing plate travels.

2. The electronic device according to claim 1,
wherein the half mirror comprises a concave surface on a side of the reflective polarizing plate.

3. The electronic device according to claim 1,
wherein the reflective liquid crystal display device comprises a linear polarizing plate, a liquid crystal layer, and a reflective layer,
wherein the planar light source, the linear polarizing plate, the liquid crystal layer, and the reflective layer are positioned in this order.

4. The electronic device according to claim 3, comprising a second retardation plate between the linear polarizing plate and the liquid crystal layer.

5. The electronic device according to claim 1,
wherein the planar light source comprises a light-emitting source and a light guide plate,
wherein the light-emitting source comprises a first light-emitting source, a second light-emitting source, and a third light-emitting source,
wherein the first light-emitting source is configured to emit red light,
wherein the second light-emitting source is configured to emit green light,
wherein the third light-emitting source is configured to emit blue light, and
wherein the first light-emitting source, the second light-emitting source, and the third light-emitting source are each configured to adjust illuminance.

6. The electronic device according to claim 1, wherein a lens is positioned between the planar light source and the reflective polarizing plate.

7. An electronic device comprising:
a transflective liquid crystal display device, a planar light source, a reflective polarizing plate, a retardation plate, and a half mirror,
wherein a surface opposite to a display surface of the transflective liquid crystal display device faces a light-emitting surface of the planar light source,
wherein the reflective polarizing plate is positioned at an angle at which light that is emitted from the display surface and travels straight is incident obliquely, and
wherein the reflective polarizing plate, the retardation plate, and the half mirror are positioned in this order in a direction in which the light reflected by the reflective polarizing plate travels.

8. The electronic device according to claim 7,
wherein the half mirror comprises a concave surface on a side of the reflective polarizing plate.

9. The electronic device according to claim 7,
wherein the transflective liquid crystal display device comprises a first linear polarizing plate, a liquid crystal layer, a transflective layer, and a second linear polarizing plate,
wherein the reflective polarizing plate, the first linear polarizing plate, the liquid crystal layer, the transflective layer, and the second linear polarizing plate are positioned in this order.

10. The electronic device according to claim 9,
wherein the transflective layer is a half mirror type.

11. The electronic device according to claim 9,
wherein the transflective layer comprises a reflective layer and a light-transmitting layer. cm 12. The electronic device according to claim 7,
wherein the planar light source comprises a light-emitting source and a light guide plate,
wherein the planar light source comprises a reflective layer on a surface opposite to the light-emitting surface,
wherein the light-emitting source comprises a first light-emitting source, a second light-emitting source, and a third light-emitting source,
wherein the first light-emitting source is configured to emit red light,
wherein the second light-emitting source is configured to emit green light,
wherein the third light-emitting source is configured to emit blue light, and
wherein the first light-emitting source, the second light-emitting source, and the third light-emitting source are each configured to adjust emission intensity.

13. The electronic device according to claim 7,
wherein the planar light source is configured to transmit light,
wherein the planar light source comprises a light-emitting source and a light guide plate,
wherein the light-emitting source comprises a first light-emitting source, a second light-emitting source, and a third light-emitting source,
wherein the first light-emitting source configured to emit red light,
wherein the second light-emitting source is configured to emit green light,
wherein the third light-emitting source is configured to emit blue light, and
wherein the first light-emitting source, the second light-emitting source, and the third light-emitting source are each configured to adjust emission intensity.

14. The electronic device according to claim 13, comprising a housing,
wherein the transflective liquid crystal display device, the planar light source, the reflective polarizing plate, the retardation plate, and the half mirror are stored in the housing, and
wherein a lighting window is positioned in a region overlapping with the planar light source in the housing.

15. The electronic device according to claim 7,
wherein a lens is positioned between the transflective liquid crystal display device and the reflective polarizing plate.

16. A method for operating an electronic device comprising a reflective liquid crystal display device or a transflective liquid crystal display device on which first light is incident from a first light source and second light is incident from a second light source, the method comprising:
obtaining a first illuminance and a first chromaticity of the first light emitted from the first light source;
changing a second illuminance of the second light source so as to have a negative slope with respect to the first illuminance; and
changing a second chromaticity of the second light emitted from the second light source in accordance with the first chromaticity such that a color of combined light of the first light and the second light is close to white light.

17. The method according to claim 16,
wherein the first light source is external light.
